(19) United States
(12) Patent Application Publication
(10) Pub. No.: US 2015/0212518 A1
(43) Pub. Date: Jul. 30, 2015

(54) EQUIPMENT SELECTION DEVICE, EQUIPMENT SELECTION PROCESSING PROGRAM, AND EQUIPMENT SELECTION PROCESSING

(71) Applicant: Kabushiki Kaisha Yaskawa Denki, Kitakyushu-shi (JP)

(72) Inventors: Nobuhiro UMEDA, Kitakyushu-shi (JP); Minoru KOGA, Kitakyushu-shi (JP); Yoshihisa MUTA, Kitakyushu-shi (JP); Takeshi NAGATA, Kitakyushu-shi (JP); Takehiko KOMIYA, Kitakyushu-shi (JP)

(73) Assignee: Kabushiki Kaisha Yaskawa Denki, Kitakyushu-shi (JP)

(21) Appl. No.: 14/678,324

(22) Filed: Apr. 3, 2015

Related U.S. Application Data
(63) Continuation of application No. PCT/JP2012/075711, filed on Oct. 3, 2012.

(51) Int. Cl. G05B 19/418; H02P 5/00

(52) U.S. Cl. CPC G05B 19/41835; H02P 5/00

(57) ABSTRACT

An equipment selection device for selecting peripheral equipment including servo motors and motor control devices in a multi-axis drive system includes circuitry which receives, for each operation axis, a selection of a speed pattern from available speed patterns determined in advance, receives, for each operation axis, a selection of a driven mechanism from available driven mechanisms determined in advance, extracts, for each operation axis, in response to receiving the selection of the driven mechanism and from servo motors and motor control devices determined in advance, one or more servo motors and motor control devices matching variation of a load mass borne by the selected mechanism when operating in conjunction with other mechanisms and matching the selected pattern, generates a list from the extracted servo motor or motors and motor control device or devices, displays the list, and receives selection from the list.

### CROSS-REFERENCE TO RELATED APPLICATIONS

The present application is continuation of and claims the benefit of priority to International Application No. PCT/JP2012/075711, filed Oct. 3, 2012, the entire contents of which are incorporated herein by reference.

### BACKGROUND OF THE INVENTION

1. Field of the Invention

Embodiments of the disclosure relate to an equipment selection device and an equipment selection processing program, and to an equipment selection processing method.

2. Description of Background Art

Japanese Patent Laid-Open Publication No. 2006-42589 describes a servo motor selection processing device in which, when a driven mechanism (for example, a ball screw mechanism) is selected, and further mechanical specifications are input, and further a movement pattern of a load is input, via a input device, required specifications of a corresponding servo motor are obtained and servo motors matching conditions of the required specifications are listed. The entire contents of this publication are incorporated herein by reference.

### SUMMARY OF THE INVENTION

According to one aspect of the present invention, an equipment selection device for selecting peripheral equipment including servo motors and motor control devices in a multi-axis drive system in which multiple driven mechanisms operate in conjunction with each other based on driving forces of the servo motors includes circuitry which receives, for each operation axis, a selection of a speed pattern from available speed patterns that are determined in advance, receives, for each operation axis, a selection of a driven mechanism from available driven mechanisms that are determined in advance, extracts, for each operation axis, in response to receiving the selection of the driven mechanism and from multiple servo motors and multiple motor control devices that are determined in advance, one or more servo motors and one or more motor control devices that match variation of a load mass borne by the selected driven mechanism when operating in conjunction with other driven mechanisms and that match the selected speed pattern, generates a list from the extracted servo motor or motors and motor control device or devices, displays the list including the servo motor or motors and the motor control device or devices, and receives selection from the list of a servo motor and a motor control device.

According to another aspect of the present invention, an equipment selection device for selecting peripheral equipment including servo motors and motor control devices in a multi-axis drive system in which multiple driven mechanisms operate in conjunction with each other based on driving forces of the servo motors includes circuitry which acquires, for each driven mechanism of multiple driven mechanisms, a combination of variation of a load mass that is borne by the respective driven mechanism when operating in conjunction with other driven mechanisms and variation of a speed pattern related to the respective driven mechanism, the variation of the load mass and the variation of the speed pattern being determined in advance for each operation mode when the multi-axis drive system performs according to multiple predetermined operation modes, receives, for each operation axis, a selection of a driven mechanism from available driven mechanisms that are determined in advance, extracts, for each operation axis and from multiple servo motors and multiple motor control devices that are determined in advance, one or more servo motors and one or more motor control devices that match the selected driven mechanism by matching a respective combination of variations of the selected driven mechanism, generates a list from the extracted servo motor or motors and motor control device or devices, displays the list including the servo motor or motors and the motor control device or devices, and receives selection from the list of a servo motor and a motor control device.

According to yet another aspect of the present invention, an equipment selection device for selecting peripheral equipment including servo motors and motor control devices in designing a multi-axis drive system in which multiple driven mechanisms individually driven by one of the servo motors operate in conjunction with each other includes circuitry which receives, for each operation axis, a selection of a driven mechanism from available driven mechanisms that are determined in advance, compute a load pattern that represents a variation of a load of an object operated by the selected driven mechanism based on operations of other driven mechanisms, compute a necessary driving torque pattern that is required by a servo motor that drives the selected driven mechanism in order to operate the load represented by the computed load pattern, and select a servo motor and a motor control device that are capable of driving the selected driven mechanism based on the computed necessary driving torque pattern.

According to still another aspect of the present invention, a computer readable medium has stored thereon a program that when executed by a computer causes the computer having circuitry to execute an equipment selection method for selecting peripheral equipment including servo motors and motor control devices in a multi-axis drive system in which multiple driven mechanisms operate in conjunction with each other based on driving forces of the servo motors. The equipment selection method includes receiving, for each operation axis, a selection of a speed pattern from available speed patterns, receiving, for each operation axis, a selection of a driven mechanism from available driven mechanisms that are determined in advance, extracting, using the circuitry, for each operation axis, in response to receiving the selection of the driven mechanism, and from multiple servo motors and multiple motor control devices that are determined in advance, one or more servo motors and one or more motor control devices that match variation of a load mass borne by the selected driven mechanism when operating in conjunction with other driven mechanisms and that match the selected speed pattern, generating, using the circuitry, a list from the extracted servo motor or motors and motor control device or devices, displaying the list including the servo motor or motors and the motor control device or devices, and receiving selection from the list of a servo motor and a motor control device.

According to still another aspect of the present invention, a computer readable medium has stored thereon a program that when executed by a computer causes the computer having circuitry to execute an equipment selection method for selecting peripheral equipment including servo motors and motor control devices in a multi-axis drive system in which multiple driven mechanisms operate in conjunction with each other based on driving forces of the servo motors. The equipment selection method includes acquiring, for each driven mechanism of multiple driven mechanisms, a combination of variation of a load mass that is borne by the respective driven mechanism when operating in conjunction with other driven mechanisms and variation of a speed pattern related to the respective driven mechanism, the variation of the load mass and the variation of the speed pattern being determined in advance for each operation mode when the multi-axis drive system performs according to predetermined operation modes, receiving, for each operation axis, a selection of a driven mechanism from available driven mechanisms that are determined in advance, extracting, using the circuitry, for each operation axis, and from multiple servo motors and multiple motor control devices that are determined in advance, one or more servo motors and one or more motor control devices that match the selected driven mechanism by matching a respective combination of variations of the selected driven mechanism, generating a list from the extracted servo motor or motors and motor control device or devices, displaying the list including the servo motor or motors and the motor control device or devices, and receiving selection from the list of a servo motor and a motor control device.

According to still another aspect of the present invention, a computer readable medium has stored thereon a program that when executed by a computer causes the computer having circuitry to execute an equipment selection method for selecting peripheral equipment including servo motors and motor control devices in designing a multi-axis drive system in which multiple driven mechanisms individually driven by one of the servo motors operate in conjunction with each other. The equipment selection method includes receiving, for each operation axis, a selection of a driven mechanism from available driven mechanisms that are determined in advance, computing, using the circuitry, a load pattern that represents a variation of a load of an object operated by the selected driven mechanism based on operations of other driven mechanisms, computing, using the circuitry, a necessary driving torque pattern that is required by a servo motor that drives the selected driven mechanism in order to operate the load represented by the computed load pattern, and selecting a servo motor and a motor control device that are capable of driving the selected driven mechanism based on the computed necessary driving torque pattern.

According to still another aspect of the present invention, an equipment selection method for selecting peripheral equipment including servo motors and motor control devices in a multi-axis drive system in which multiple driven mechanisms operate in conjunction with each other based on driving forces of the servo motors includes receiving, for each operation axis, a selection of a speed pattern from available speed patterns, receiving, for each operation axis, a selection of a driven mechanism from available driven mechanisms that are determined in advance, extracting, using circuitry, for each operation axis, in response to receiving the selection of the driven mechanism, and from multiple servo motors and multiple motor control devices that are determined in advance, one or more servo motors and one or more motor control devices that match variation of a load mass borne by the selected driven mechanism when operating in conjunction with other driven mechanisms and that match the selected speed pattern, generating, using the circuitry, a list from the extracted servo motor or motors and motor control device or devices, displaying the list including the servo motor or motors and the motor control device or devices, and receiving selection from the list of a servo motor and a motor control device.

According to still another aspect of the present invention, an equipment selection method for selecting peripheral equipment including servo motors and motor control devices in a multi-axis drive system in which multiple driven mechanisms operate in conjunction with each other based on driving forces of the servo motors includes acquiring, for each driven mechanism of multiple driven mechanisms, a combination of variation of a load mass that is borne by the respective driven mechanism when operating in conjunction with other driven mechanisms and variation of a speed pattern related to the respective driven mechanism, the variation of the load mass and the variation of the speed pattern being determined in advance for each operation mode when the multi-axis drive system performs according to predetermined operation modes, receiving, for each operation axis, a selection of a driven mechanism from available driven mechanisms that are determined in advance, extracting, using circuitry, for each operation axis, and from multiple servo motors and multiple motor control devices that are determined in advance, one or more servo motors and one or more motor control devices that match the selected driven mechanism by matching a respective combination of variations of the selected driven mechanism, generating a list from the extracted servo motor or motors and motor control device or devices, displaying the list including the servo motor or motors and the motor control device or devices, and receiving selection from the list of a servo motor and a motor control device.

According to still another aspect of the present invention, an equipment selection method for selecting peripheral equipment including servo motors and motor control devices in designing a multi-axis drive system in which multiple driven mechanisms individually driven by one of the servo motors operate in conjunction with each other includes receiving, for each operation axis, a selection of a driven mechanism from available driven mechanisms that are determined in advance, computing, using circuitry, a load pattern that represents a variation of a load of an object operated by the selected driven mechanism based on operations of other driven mechanisms, computing, using the circuitry, a necessary driving torque pattern that is required by a servo motor that drives the selected driven mechanism in order to operate the load represented by the computed load pattern, and selecting a servo motor and a motor control device that are capable of driving the selected driven mechanism based on the computed necessary driving torque pattern.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates an overall external appearance of a motor equipment selection device according to an embodiment;

FIG. 2 illustrates a software block diagram schematically illustrating a processing configuration of an equipment selection application that a PC executes;

FIGS. 3A and 3B illustrate an example of a multi-axis drive system;

FIG. 4 illustrates a detailed structure of a table movement mechanism;

FIG. 5 illustrates an example of an operation screen for performing input and setting of respective conditions and arithmetic expressions;

FIG. 6 illustrates an example of an operation screen that sets a speed pattern of a single axis;

FIG. 7 illustrates an example of an operation screen that sets speed patterns of multiple axes;

FIG. 8 illustrates an example of an operation screen that sets a mechanism condition;

FIGS. 9A and 9B illustrate an example of a speed pattern and a necessary driving torque pattern of an X-axis;

FIG. 10 illustrates an example of a display screen of selection results of an actual waveform of a necessary driving torque pattern and required characteristics;

FIG. 11 described a method for calculating a load pattern;

FIG. 12 illustrates an example of an operation process of a multi-axis drive system and speed patterns corresponding to the operation process;

FIG. 13 illustrates an example of an operation process of a multi-axis drive system and load patterns corresponding to the operation process;

FIG. 14 illustrates an example of an operation process of a multi-axis drive system and necessary driving torque patterns corresponding to the operation process;

FIG. 15 schematically summarizes a selection processing process of motor equipment of each operation axis;

FIG. 16 illustrates an example of a flowchart illustrating control content that a CPU of a PC executes in order to realize the selection processing of the motor equipment;

FIG. 17 illustrates an example of a display screen of required characteristics of a multi-axis servo controller and a selection result in a case where necessary driving torque patterns of operation axes are collectively considered;

FIG. 18 schematically summarizes a selection processing process of a multi-axis servo controller in a case where selection results of operation axes are listed alongside and considered; and

FIG. 19 schematically summarizes a selection processing process of a modified embodiment in which complicated load patterns are imported.

### DETAILED DESCRIPTION OF THE EMBODIMENTS

The embodiments will now be described with reference to the accompanying drawings, wherein like reference numerals designate corresponding or identical elements throughout the various drawings.

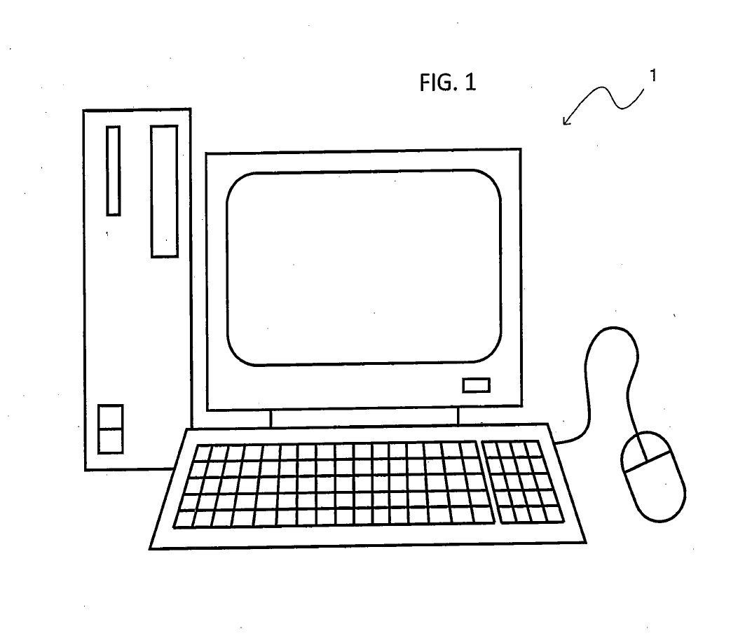

FIG. 1 illustrates an overall external appearance of an equipment selection device according to an embodiment. The equipment selection device of the example illustrated in FIG. 1 is realized by a common personal computer 1 (hereinafter, abbreviated to PC), and equipment selection processing is realized by a software application that runs in the PC 1. Although not particularly illustrated in the drawings, the PC 1 includes common PC configuration components such as a CPU, a ROM, a RAM, a HDD, a removable media drive (such as a DVD drive), a keyboard, a pointing device (such as a mouse), a display and a network interface, and a description about other detailed hardware structure of the PC 1 is omitted.

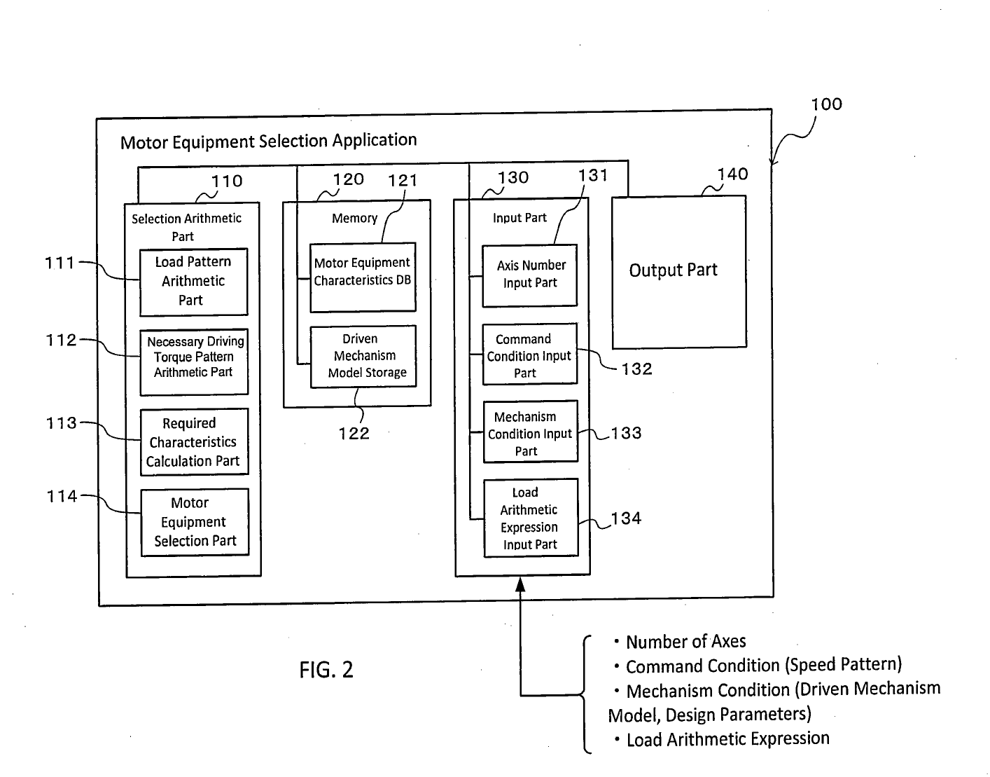

FIG. 2 illustrates a software block diagram schematically illustrating a processing configuration of an equipment selection application that the PC 1 executes. The equipment selection application 100 performs, with respect to a motor equipment that is included in a multi-axis drive system that a user is trying to design, selection processing of a motor equipment that matches a command condition and a mechanism condition (both will be described later) of the multi-axis drive system. In the following, the motor equipment is a general term for a motor, a motor control device and peripheral equipment related to motor control. Further, the equipment selection application 100 corresponds to an equipment selection program, and, among the configuration components of the PC 1, a functional part that executes the program corresponds to an equipment selection device.

First, a processing configuration of the equipment selection application 100 of the present embodiment is described. In FIG. 2, the equipment selection application 100 includes a selection arithmetic part 110, a memory 120, an input part 130 and an output part 140.

First, the input part 130 includes an axis number input part 131, a command condition input part 132, a mechanism condition input part 133 and a load arithmetic expression input part 134.

The axis number input part 131 has a function of inputting a number of operation axes of a multi-axis drive system to be designed, that is, a number of motors required to drive the multi-axis drive system (hereinafter, a motor may be referred to as an operation axis as appropriate).

The command condition input part 132 has a function of inputting a speed pattern as a command condition that is envisioned to be output by a control object of the operation axes in the multi-axis drive system.

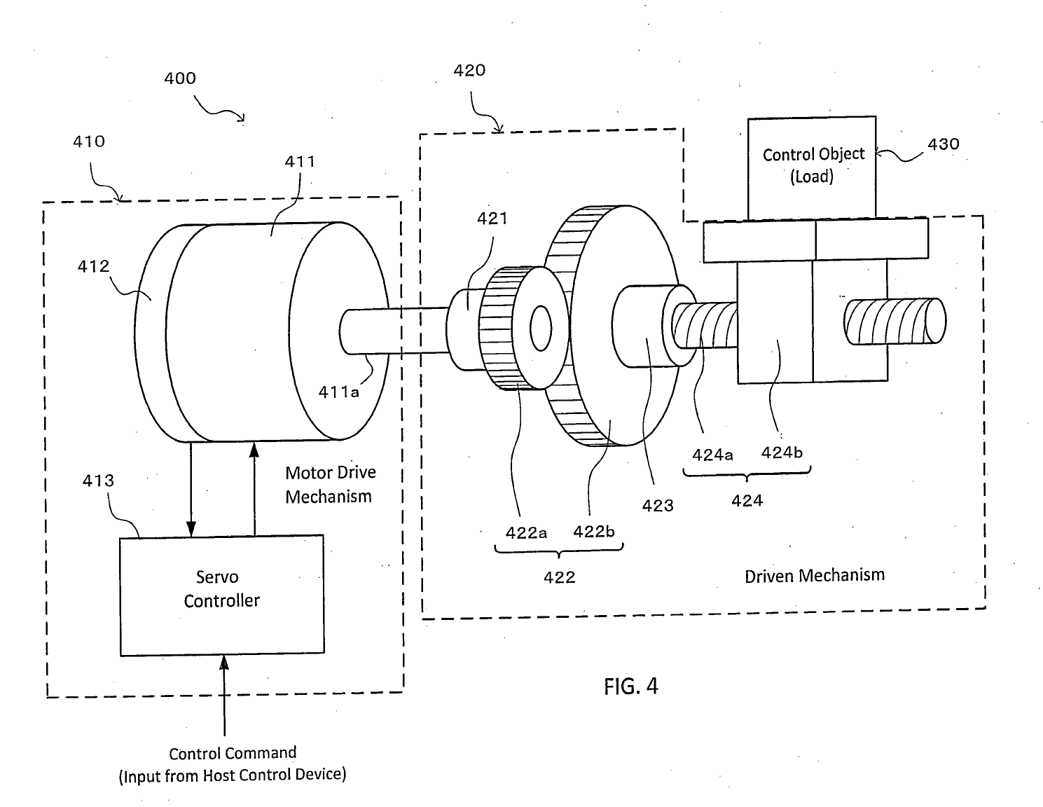

The mechanism condition input part 133 has a function of inputting, for a driven mechanism driven by each operation axis in the multi-axis drive system, a driven mechanism model that defines mechanistic content of the driven mechanism and detailed design parameters of the driven mechanism as a mechanism condition. The control object, the command condition, the driven mechanism and the mechanism condition will be described in detail later with reference to FIG. 4.

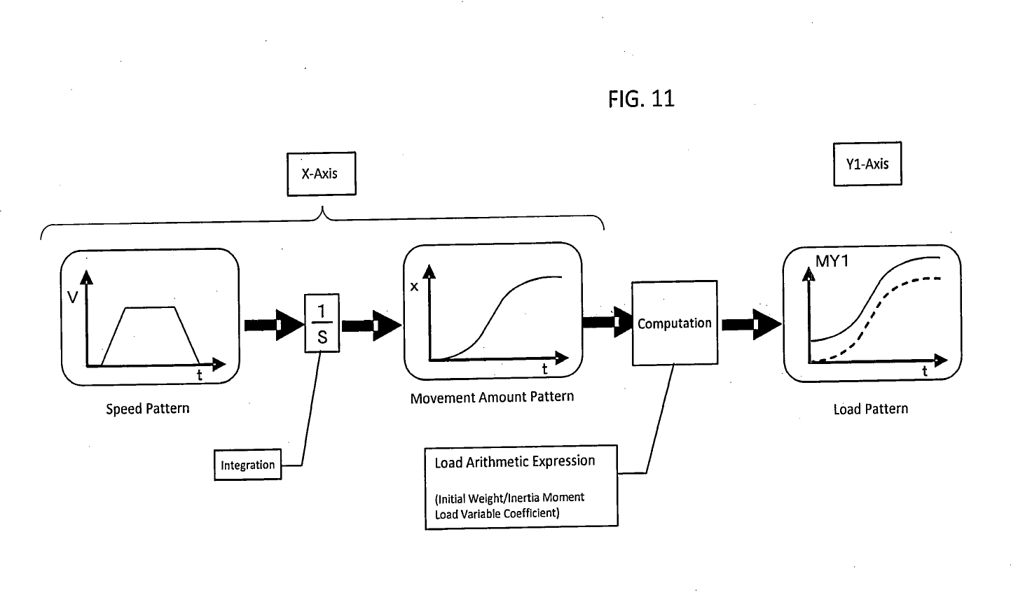

The load arithmetic expression input part 134 has a function of inputting, for each operation axis, a load arithmetic expression that is used when a load pattern is computed that represents a mode in which a load of a control object of the operation axis varies due to operations of other operation axes. The load pattern and the load arithmetic expression will be described in detail later with reference to FIG. 11.

Next, the memory 120 includes a motor equipment characteristics database 121 (abbreviated to DB in FIG. 2) and driven mechanism model storage 122. The motor equipment characteristics database 121 stores, in association with each other, names of various motor equipment and their respective specification characteristics. A name of motor equipment may be a model number or a serial number of the motor equipment. The driven mechanism model storage 122 stores, for each of all kinds of the driven mechanisms that can be normally used, a calculation expression or the like of a mathematical model that is used when a necessary driving force of the driven mechanism is calculated.

Next, the selection arithmetic part 110 includes a load pattern arithmetic part 111, a necessary driving torque pattern arithmetic part 112, a required characteristics calculation part 113, and a motor equipment selection part 114.

The load pattern arithmetic part 111 has a function of computing a load pattern that represents variation of a load of a control object of a predetermined operation axis based on a command condition input using the command condition input part 132 and a load arithmetic expression input using the load arithmetic expression input part 134.

The necessary driving torque pattern arithmetic part 112 has a function of computing a necessary driving torque pattern that is required for each operation axis in order to drive the entire driven mechanism, the computation being performed with reference to the driven mechanism model storage 122 and based on a mechanism condition input using the mechanism condition input part 133, a command condition input using the command condition input part 132 and a load pattern computed using the load pattern arithmetic part 111.

The required characteristics calculation part 113 has a function of calculating required characteristics that are required by a motor equipment of the operation axis based on a necessary driving torque pattern computed by the necessary driving torque pattern arithmetic part 112.

The motor equipment selection part 114 has a function of selecting and obtaining motor equipment from the motor equipment characteristics database 121 based on the required characteristics calculated by the required characteristics calculation part 113, the motor equipment having specification characteristics that minimally satisfy and match the required characteristics. The required characteristics calculation part 113 and the motor equipment selection part 114 correspond to an equipment selection part. Further, the load pattern, the necessary driving torque pattern and the required characteristics will be described in detail later.

Next, the output part 140 has a function of outputting a screen for performing input operations of the input part 130 and a name or the like of the motor equipment selected using the motor equipment selection part 114 to a display device such as a display to be presented to a user. The display corresponds to a display part.

In the following, a method for selecting motor equipment according to the present embodiment is described using an example of a specific multi-axis drive system.

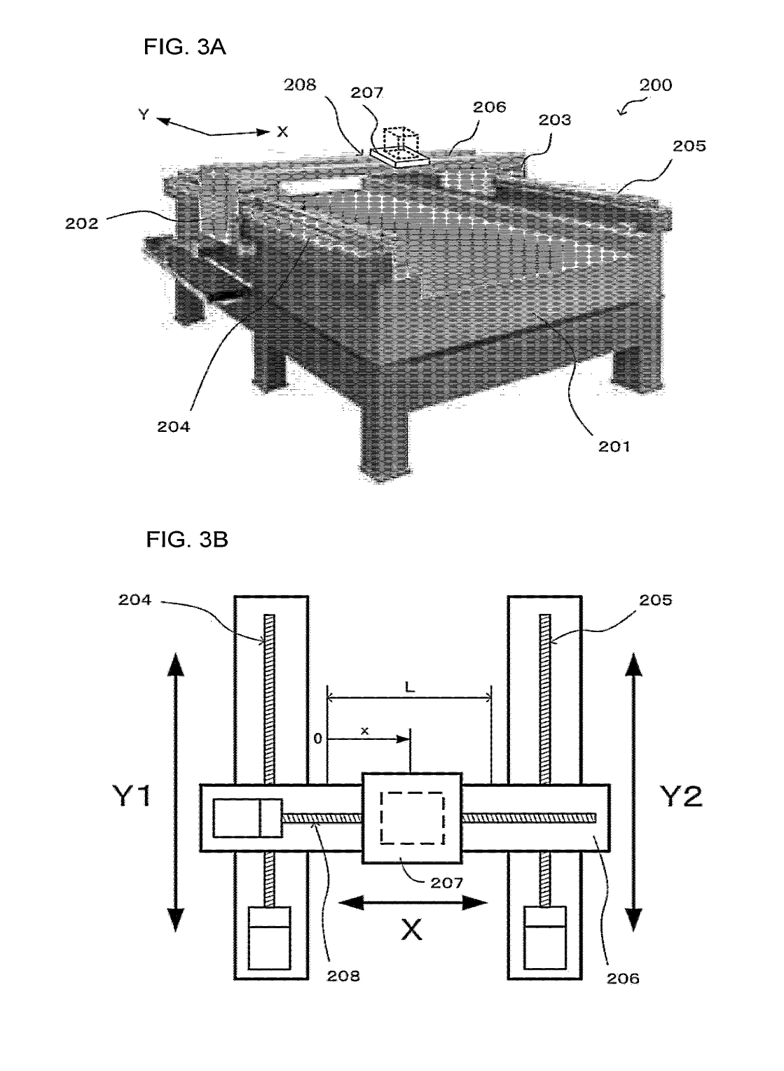

An example of a multi-axis drive system that is an object with respect to which selection of motor equipment is performed by the motor equipment selection device (equipment selection application 100) of the present embodiment is illustrated in FIGS. 3A and 3B. The multi-axis drive system of the example illustrated in FIGS. 3A and 3B is an X-Y table 200 that uses a so-called gantry mechanism. As illustrated in an external perspective view in FIG. 3A, the X-Y table 200 is provided with a substantially rectangular parallelepiped horizontal base 201, and two Y-axis table movement mechanisms (204, 205) that can respectively move Y-axis movable tables (202, 203) along a long-side direction (Y direction) are provided on long-side parts on both sides of the horizontal base 201. A movable beam 206 is extended in an arrangement parallel to a short-side direction (X direction) between the two Y-axis movable tables (202, 203), and further an X-axis table movement mechanism 208 that can move an X-axis movable table 207 along the short-side direction is provided on the movable beam 206.

In this example, the two Y-axis table movement mechanisms (204, 205) and the X-axis table movement mechanism 208 are respectively driven mechanisms that are each provided with a horizontal ball screw mechanism driven by a rotary servo motor. Further, as illustrated in FIG. 3B, a movement direction of the Y-axis movable table 202 on one side is a Y1-axis direction (left side in FIG. 3B), a movement direction of the Y-axis movable table 203 on the other side is a Y2-axis (right side in FIG. 3B), and a movement direction of the X-axis movable table 207 is an X-axis direction. By causing the three table movement mechanisms (204, 205, 208) to cooperatively operate, a multi-axis control system of the X-Y table 200 that is structured as described above can control X-Y coordinate movement on a horizontal plane of an equipment (see a broken-line part in FIGS. 3A and 3B) that is fixed on the X-axis movable table 207. The X-axis table movement mechanism 208 corresponds to an X-axis driven mechanism, the Y1-axis table movement mechanism 204 corresponding to the Y1-axis corresponds to a Y1-axis movement mechanism, and the Y2-axis table movement mechanism 205 corresponding to the Y2-axis corresponds to a Y2-axis movement mechanism.

A detailed structure of each of the table movement mechanisms is illustrated in FIG. 4. The structure of the table movement mechanisms (204, 205, 208) of the axial directions of the Y1, Y2 and X axes are different in detailed design parameters, but are basically the same as the structure illustrated in FIG. 4. A table movement mechanism 400 of an example illustrated in FIG. 4 schematically includes a motor drive mechanism 410, a driven mechanism 420 and a control object 430.

The motor drive mechanism 410 has a servo motor 411, an encoder 412 and a servo controller 413. The servo motor 411 in this example is a rotary motor and rotationally drives an output shaft (411a) according to drive power supplied from the servo controller 413. The encoder 412 is structured by, for example, an optical rotation speed detector and the like, and detects a rotation position and a rotation angular speed of the output shaft (411a) of the servo motor with sufficient accuracy. The servo controller 413 controls the drive power supplied to the servo motor 411 with reference to detection information from the encoder 412 and in particular based on a drive control command input from a host control device (not illustrated in the drawings). The servo controller 413 corresponds to a motor control device.

Further, in the driven mechanism 420 of the example illustrated in FIG. 4, a coupling 421, a reducer 422, a coupling 423 and a horizontal ball screw mechanism 424 are provided in this order from the output shaft (411a) of the servo motor in a manner of being coupled to the output shaft (411a). The reducer 422, which is a power transmission element, is a gear type reducer element in which two reduction gears, a drive gear (422a) and a driven gear (422b), having different numbers of teeth engage each other. The horizontal ball screw mechanism 424 is an actuator mechanism in which a horizontally arranged ball screw (424a) penetrates through and threadably engages a movable table (424b) and, by normally and reversely rotating the ball screw (424a), the movable table (424b) is caused to move along an axial direction in a movement direction corresponding to the rotation direction of the ball screw (424a). The two couplings (421, 423) are power transmission elements that couple the drive gear (422a) and the driven gear (422b) of the reducer 422 to transmit a rotation drive force respectively with respect to the output shaft (411a) of the servo motor 411 and the ball screw (424a) of the horizontal ball screw mechanism 424.

The control object 430 is an object that is fixed on an output part of the driven mechanism 420, that is, on the movable table (424b) of this example, and is caused to linearly move. For example, in the case of the Y1-axis table movement mechanism 204 and the Y2-axis table movement mechanism 205, portions of a combination combining the movable beam 206 and the X-axis table movement mechanism 208 that are respectively borne by the Y1-axis and the Y2-axis are respectively the control objects 430 of the Y1-axis table movement mechanism 204 and the Y2-axis table movement mechanism 205. Further, in the case of the X-axis table movement mechanism 208, the equipment (see the broken-line part in FIG. 3A) that is placed on the X-axis movable table 207 is the control object 430.

A multi-axis drive system having the motor drive mechanism 410 and the driven mechanism 420 may be a virtual system in a design stage rather than an actually manufactured system. In the present embodiment, the driven mechanism 420 has a structure in which, as described above, all power transmission elements are coupled in series in only one row from the output shaft (411a) of the servo motor. In the following, a description is given of a method for selecting servo motors and servo controllers that have characteristics suitable for driving the respective table movement mechanisms (204, 205, 208) having the above-described structure in the equipment selection application 100 of the present embodiment. Selection of the encoder 412 and the like that structure the motor drive mechanism 410 will be described later.

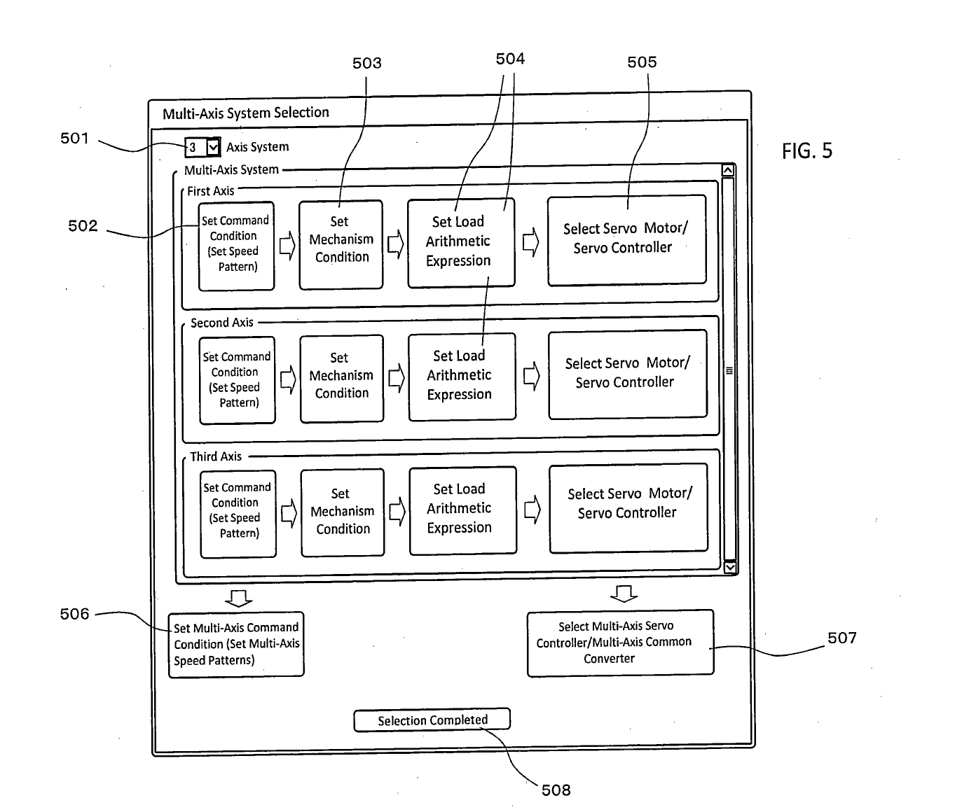

First, in general, in order to perform selection of motor equipment, it is necessary for a user to input in advance at least a command condition and a mechanism condition to the equipment selection application 100. Then, in a case of an operation axis where a load of the above-described control object varies due to operations of driven mechanisms of other axes, it is further necessary to input a load arithmetic expression. An example of an operation screen for performing input and setting of the conditions and the arithmetic expression is illustrated in FIG. 5. The operation screen illustrated in FIG. 5 is displayed in a display device such as a display by the function of the output part 140 when the equipment selection application 100 is started in the PC 1.

The operation screen includes an axis number input operation part 501, a speed diagram setting operation part 502, a mechanism setting operation part 503, a load pattern setting operation part 504, a single-axis selection operation part 505, multi-axis speed diagram setting operation part 506, a multi-axis selection operation part 507 and a setting completion operation part 508. A user can select and operate the operation parts in a predetermined order (or in any order). The user can first use the axis number input operation part 501 to input and set a number of operation axes, that is, a number of motors, included in a multi-axis drive system to be designed. The axis number input operation part 501 is an operation part that functions via the axis number input part 131. When the number of the operation axes is set, rows of operation parts are displayed arranged in an up-down direction according to the set number of axes, in each of the rows, the speed diagram setting operation part 502, the mechanism setting operation part 503, the load pattern setting operation part 504 and the single-axis selection operation part 505 being arranged in this order from a left side in FIG. 5. In the example illustrated in FIG. 5, three axes are set. Therefore, three rows corresponding to the respective operation axes are displayed.

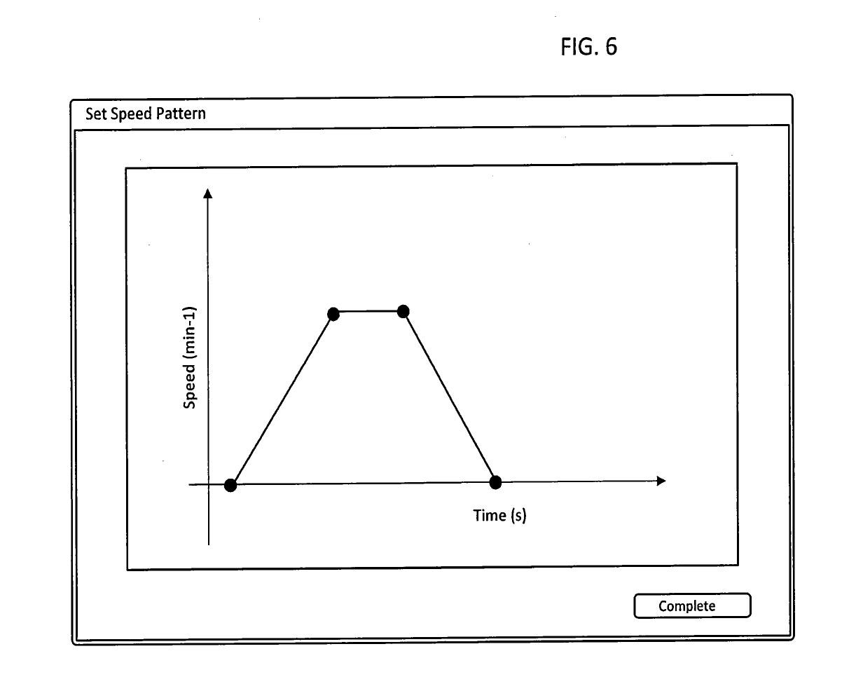

The speed diagram setting operation part 502 is an operation part that functions via the command condition input part 132, and sets an operation quantity as a command condition such as a time series variation pattern that is envisioned to be output by an output part, that is, the control object, of the driven mechanism of each of the operation axes. In the example of the present embodiment, the operation quantity is set in a command using a movement speed of the control object. Specifically, the operation quantity is set using a speed pattern (speed diagram) represented by a time series as illustrated in FIG. 6. The speed pattern may be set by a user using any pattern (any acceleration or deceleration, constant speed and time length), or may be set by selecting multiple patterns that are prepared in advance. As illustrated in FIG. 6, the setting operation screen of the speed pattern of a single axis corresponds to a first display part.

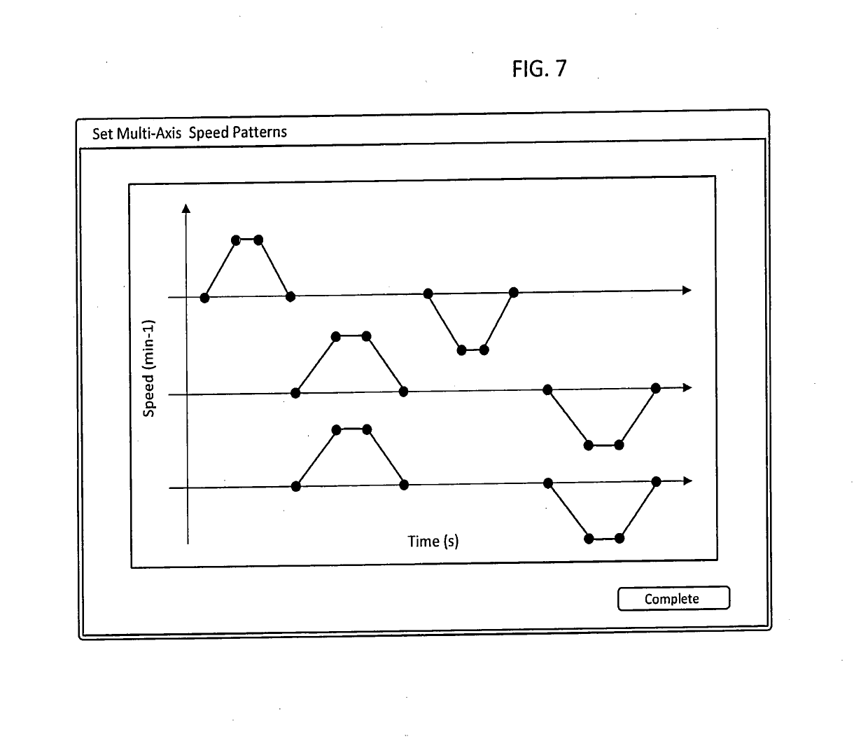

Further, in the multi-axis speed diagram setting operation part 506, as illustrated in FIG. 7, speed patterns of the control objects of all of the operation axes can be set on the same time axis. As a result, operation timings of the respective operation axes in an inter-axis cooperative operation can be set. As illustrated in FIG. 7, the setting operation screen of the speed patterns of multiple axes corresponds to a fifth display part. The command condition represented by these speed patterns may be set to have content that more intensely varies than an actually envisioned usage pattern in order to verify controllability of the entire multi-axis drive system, or may be set to have content that matches the actually envisioned usage pattern.

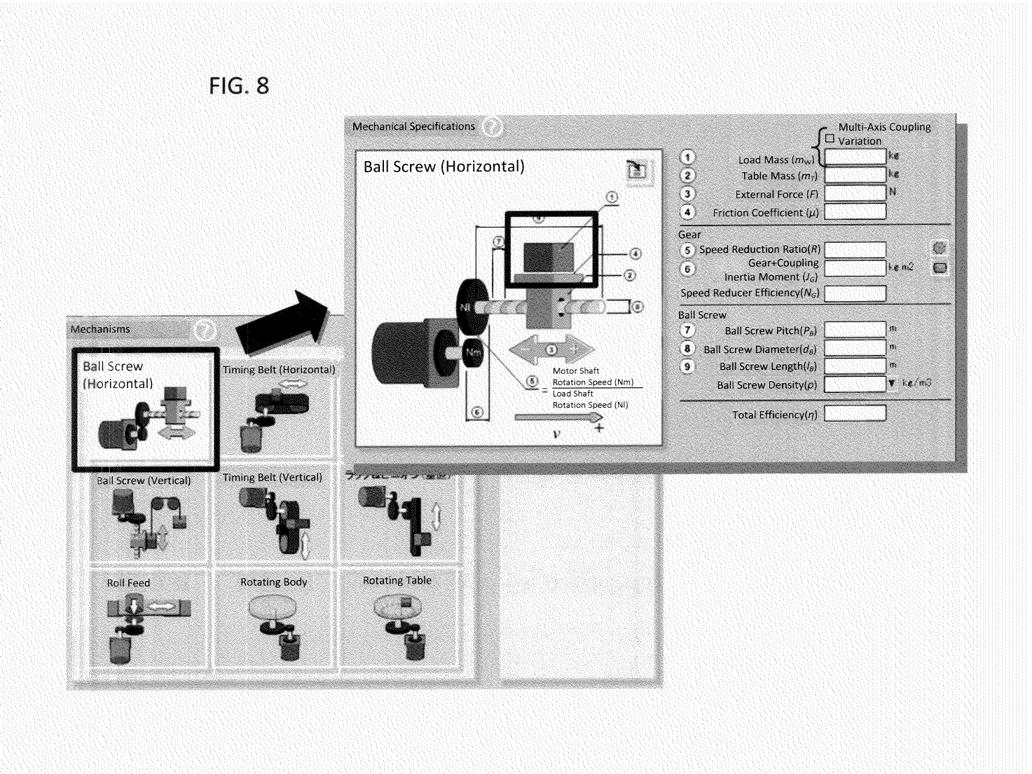

The mechanism setting operation part 503 is an operation part that functions via the mechanism condition input part 133, and sets, with respect to the driven mechanisms of the respective operation axes, an overall mechanistic type and design parameters of respective structure elements as a mechanism condition. Specifically, a large number of types of driven mechanism models stored in the driven mechanism model storage 122 are displayed as a list as illustrated in FIG. 8 (see lower left in FIG. 8), and necessary design parameters are input and set for a driven mechanism model that is selected from the list by the user (see upper right in FIG. 8). As illustrated in FIG. 8, the setting operation screen of the mechanism condition corresponds to a second display part. Further, although not particularly illustrated in the drawings, the user may select and combine multiple types of power transmission elements to design a driven mechanism model of any type. By the input of the mechanism condition, the equipment selection application 100 can recognize mechanistic content of the driven mechanism of each axis. In the input setting of the design parameters, input setting of a load mass of a control object is also performed. However, an operation of a selection option that is selected when the load mass varies due to operations of other operation axes is also possible.

Here, in the case of the multi-axis drive system of the X-Y table 200 illustrated above in FIGS. 3A and 3B, a load of the control object of the X-axis table movement mechanism 208 is not affected by the operation of the other operation axes and remains unchanged. Therefore, a load mass of the control object can be input and set as it is. In this case, there is no need to compute a load pattern (to be described later) so that, in the above operation screen of FIG. 5, the load pattern setting operation part 504 corresponding to the X-axis (the “first axis” in FIG. 5) is disabled (semi-transparently displayed). For such X-axis, at the time when the command condition and the mechanism condition are input and set, selection of the motor equipment of the X-axis can be performed.

In order to select motor equipment suitable for driving the X-axis table movement mechanism 208, it is necessary to calculate a necessary driving torque pattern and required characteristics. That is, in order to cause the control object of the X-axis table movement mechanism 208 to move with a speed pattern that is set as the command condition, for each of all the power transmission elements that structure the driven mechanism and the load of the control object, a necessary driving torque required for driving is individually analyzed based on the mechanism condition. For the element specific analysis of the necessary driving torque, torque calculation (thrust calculation) according to a formula such as T=J·dω/dt(F=m·a) can be performed, and details of the calculation are omitted here. Then, a time series pattern of a necessary driving torque required by the servo motor by accumulating the necessary driving torques of the control object and the respective power transmission elements, and the required characteristics required by the servo motor are calculated based on the necessary driving torque pattern.

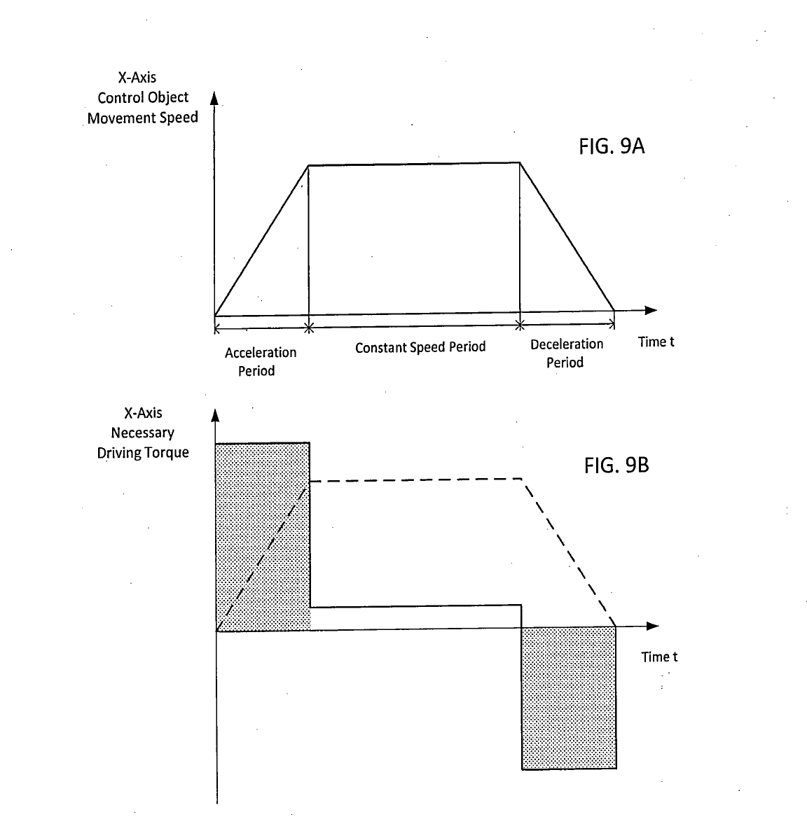

In a case where the command condition is given as a speed pattern of a movement speed as illustrated in FIG. 9A, with respect to the control object of the X-axis table movement mechanism, a necessary driving torque of the servo motor of the X-axis in order to realize this is a time series variation pattern as illustrated in FIG. 9B. The necessary driving torque pattern illustrated in FIG. 9B indicates that a positive torque with respect to a rotation direction is required in an acceleration period and a negative torque with respect to the rotation direction is required during a deceleration period (see respective shaded display areas in FIG. 9B). During a constant speed period, a constant small torque of a magnitude enough to compensate a power loss due to friction and the like is required. Further, the necessary driving torque pattern arithmetic part 112 in FIG. 2 functions to compute the necessary driving torque pattern.

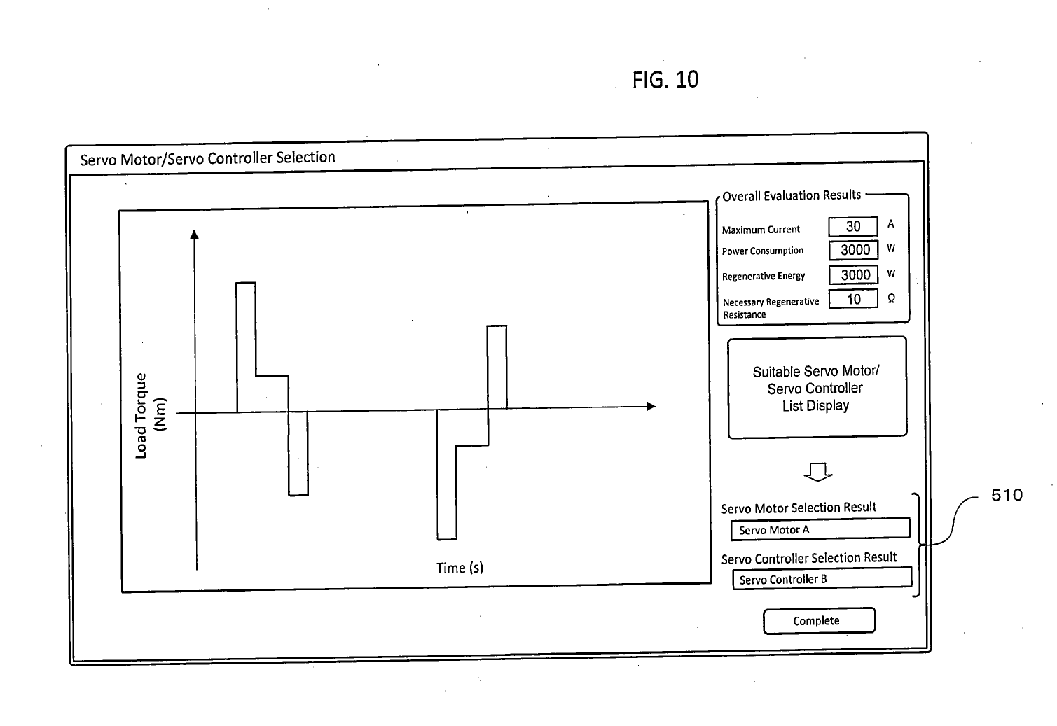

Based on the necessary driving torque pattern analyzed as described above, the required characteristics calculation part 113 in FIG. 2 calculates characteristics such as a maximum current, power consumption, regenerative energy and necessary regenerative resistance, that is, the required characteristics that are required by the motor equipment of the X-axis corresponding to the command condition. A display example of an actual waveform of such a necessary driving torque pattern and the required characteristics is illustrated in FIG. 10. Names of the motor equipment (the servo motor and the servo controller) that minimally satisfy the required characteristics are obtained by the motor equipment selection part 114 in FIG. 2 from the motor equipment characteristics database 121, and are displayed in a selection name display part 510 in FIG. 10. Thereby, the user can select suitable motor equipment of the X-axis. The selection name display part corresponds to a third display part.

On the other hand, in the case of the Y1-axis and the Y2-axis in the multi-axis drive system of the X-Y table 200 illustrated in FIGS. 3A and 3B, loads of the control objects of the respective table movement mechanisms (204, 205) vary by being affected by the operation of the X1 axis. Specifically, when the X-axis movable table 207 becomes closer to the Y1-axis, the load mass of the control object of the Y1-axis increases and the load mass of the control object of the Y2-axis decreases. Conversely, when the X-axis movable table 207 becomes closer to the Y2-axis, the load mass of the control object of the Y2-axis increases and the load mass of the control object of the Y1-axis decreases. Without taking this point into account, the motor equipment for the Y1-axis and the Y2-axis cannot be properly selected.

For example, a mass of a combination combining the X-axis movable table 207 moving on the movable beam and the X-axis control object placed on the X-axis movable table 207 is 40 kg and load masses that are portions of the mass of the combination that are respectively borne by the Y1-axis and the Y2-axis are My1 and My2, a relation of My1+My2=40 kg always holds. In this relation, a case of coordinate setting is considered where, in an x-coordinate on the X-axis illustrated in FIG. 3B, x=0 in a state in which the X-axis movable table 207 is closest to the Y1-axis and x=L in a state in which the X-axis movable table 207 is closest to the Y2-axis. For example, when x=0, the shared load mass (My1) borne by the Y1-axis side is 30 kg, and the shared load mass (My2) borne by the Y2-axis side is 10 kg. When x=L, the shared load mass (My1) borne by the Y1-axis side is 10 kg, and the shared load mass (My2) borne by the Y2-axis side is 30 kg. Then, the shared load mass (My1) decreases in proportion to the movement position x, and the shared load mass (My2) increases in proportion to the movement position x.

In this case, of the mass (40 kg) of the combination combining the X-axis movable table 207 and the X-axis control object placed on the X-axis movable table 207, the shared load masses (My1, My2) that are respectively borne by the Y1-axis and the Y2-axis can be respectively expressed by the following Expressions (1) and (2).

My1=20(L−x)/L+10 (1)

My2=20x/L+10 (2)

Further, load masses of the respective control objects of the Y1-axis table movement mechanism 204 and the Y2-axis table movement mechanism 205 include not only the shared load masses (My1, My2) obtained from the above Expressions (1) and (2), but are sums that are obtained by respectively adding shared load masses (Cy1, Cy2) to the shared load masses (My1, My2), the shared load masses (Cy1, Cy2) being with respect to a load mass of a combination combining the X-axis table movement mechanism 208 and the entire movable beam, excluding the X-axis movable table 207 (Cy1+Cy2=constant). However, the shared load masses (Cy1, Cy2) are respectively fixed values that are not affected by the movement position x of the X-axis and do not vary. As a result, the load masses (MY1, MY2) of the respective control objects of the Y1-axis table movement mechanism 204 and the Y2-axis table movement mechanism 205 can be expressed as by the following Expressions (3) and (4).

MY1=My1+Cy1=20(L−x)/L+10+Cy1 (3)

MY2=My2+Cy2=20x/L+10+Cy2 (4)

These two expressions are respectively the load arithmetic expressions of the control objects of the Y1-axis table movement mechanism 204 and the Y2-axis table movement mechanism 205, and it is clear that, in the case of the X-Y table 200 of FIGS. 3A and 3B, the load arithmetic expressions are respectively first order expressions of the movement position x of the X-axis movable table 207.

As described above, there is often a case where load masses of multiple axes that operate in conjunction with each other can each be individually obtained using an arithmetic expression that involves operation quantities (such as acceleration, speed, displacement, and inclination) of other operation axes. Such a relational arithmetic expression can be created as a load arithmetic expression by a designing user who understands a mechanistic structure of the multi-axis drive system, and the load arithmetic expression can be input using the load pattern setting operation part 504 illustrated in FIG. 5. That is, even in the case where the load masses of the control objects of the respective operation axes of the multi-axis drive system vary by being mutually affected by operation quantities of the other operation axes, the load masses of the control objects of the respective operation axes can each be replaced as an increase or decrease to an apparent fixed mass and individually calculated using a load arithmetic expression.

For example, in the case of the load arithmetic expression of the Y1-axis that is expressed by the above Expression (3), as described above, the load arithmetic expression of the control object is a first order expression in which the movement position x of the X-axis movable table 207 is a variable. Therefore, it is necessary to obtained the movement position x. As illustrated in FIG. 11, the equipment selection application 100 internally performs integration calculation with respect to the speed pattern that is input as the command condition for the X-axis, and thereby, the movement position x can be obtained as a movement amount pattern that time-serially expresses variation of the movement position x. The movement amount pattern corresponds to variation of a movement amount. Then, with respect to the movement amount pattern, the load pattern arithmetic part 111 in FIG. 2 performs computation using the above load arithmetic expression of Expression (3), in which an initial weight load (corresponding to 10+Cy1 in Expression (3)) and an inertia moment load variable coefficient (corresponding to 20 in Expression (3)) are taken into account, and thereby, a load pattern can be obtained that time-serially expresses variation of the load mass (My1) of the control object of the Y1-axis. Content illustrated by the load pattern corresponds to variation of a load mass.

In the example of the present embodiment, in order to select motor equipment suitable for respectively driving the Y1-axis table movement mechanism 204 and the Y2-axis table movement mechanism 205, necessary driving torque patterns and required characteristics may be obtained that are required to respectively move, at the respective speed patterns, the load masses that are respectively illustrated by the load patterns. In the following, a specific example of the process is described.

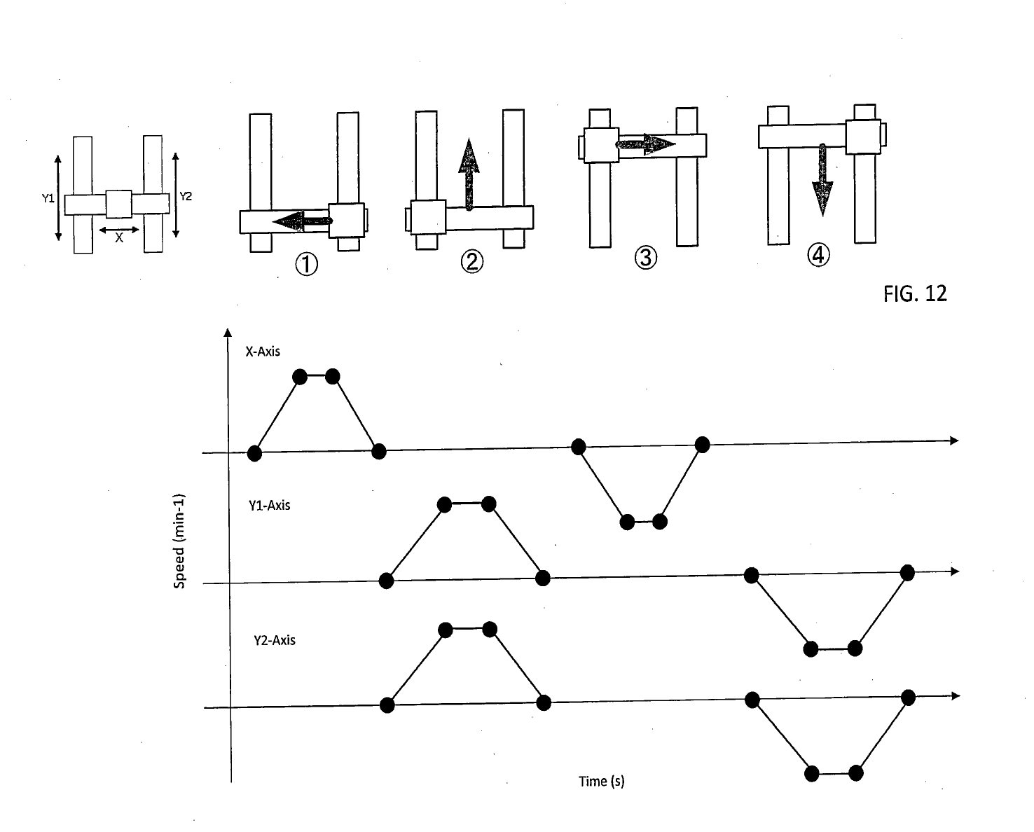

For example, a case is considered where the above X-Y table 200 illustrated in FIGS. 3A and 3B is caused to operate in a four-step process as illustrated in FIG. 12. In the example illustrated in FIG. 12, starting from a state in which the X-axis is initially at the position x=L and both the Y1-axis and the Y2-axis are positioned on a nearest side, an operation process of the first step is performed in which only the X-axis is moved to the position x=0. Next, an operation process of the second step is performed in which both the Y1-axis and the Y2-axis are moved to a farthest side. Next, an operation process of the third step is performed in which only the X-axis is moved so as to be returned to the position x=L. Next, an operation process of the fourth step is performed in which both the Y1-axis and the Y2-axis are moved so as to be returned to the nearest side, and the processing terminates. Speed patterns as illustrated in FIG. 12 are input as a command condition for performing the above-described four-step operation process.

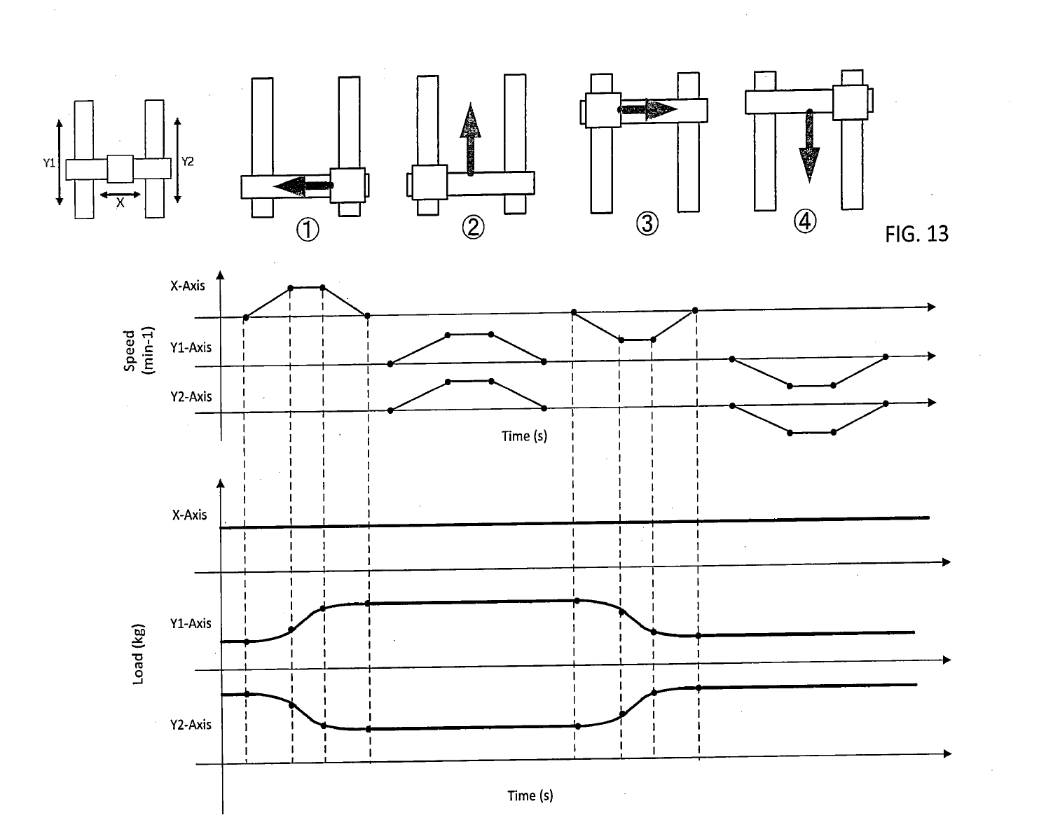

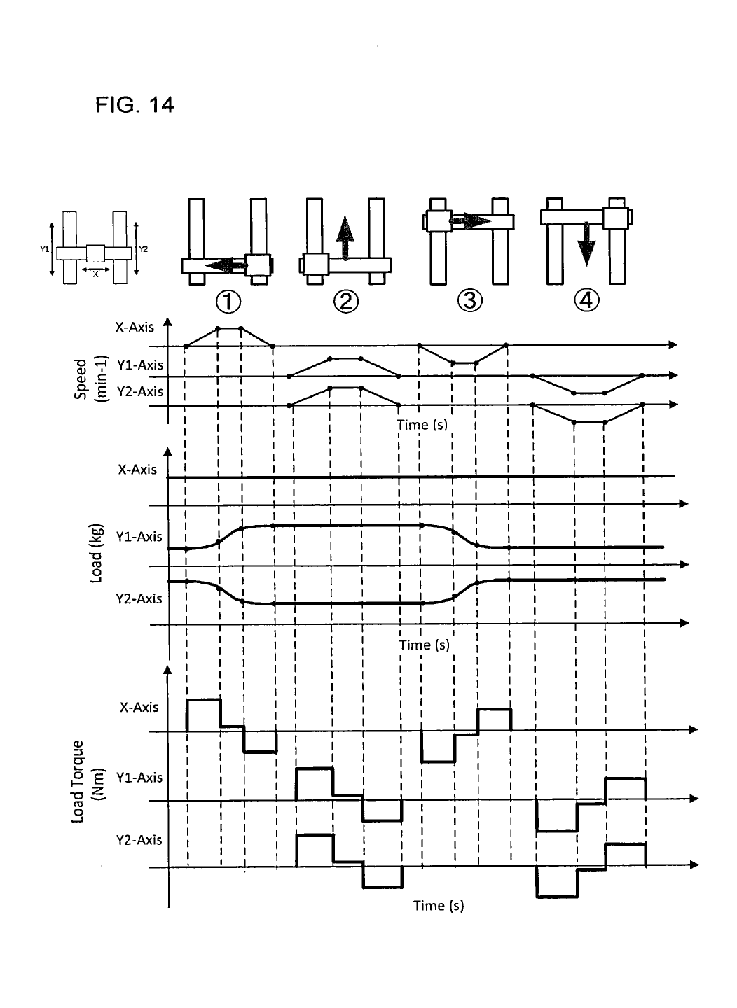

Based on the speed patterns, the equipment selection application 100 internally performs integration calculation to calculate a movement amount pattern of the X-axis (not illustrated in the drawings). Based on the movement amount pattern of the X-axis, the load pattern arithmetic part 111 in FIG. 2 computes load patterns illustrated in FIG. 13 using the load arithmetic expressions of the respective operation axes. Further, based on the load patterns, the necessary driving torque pattern arithmetic part 112 in FIG. 2 computes necessary driving torque patterns illustrated in FIG. 14 by taking into account the mechanism condition.

Based on the necessary driving torque patterns of the respective operation axes that are analyzed as described above, the required characteristics calculation part 113 in FIG. 2 calculates required characteristics of the respective operation axes. Then, the motor equipment selection part 114 in FIG. 2 selects, from the motor equipment characteristics database 121, motor equipment that minimally satisfy the required characteristics of the respective operation axes, and displays names of the motor equipment.

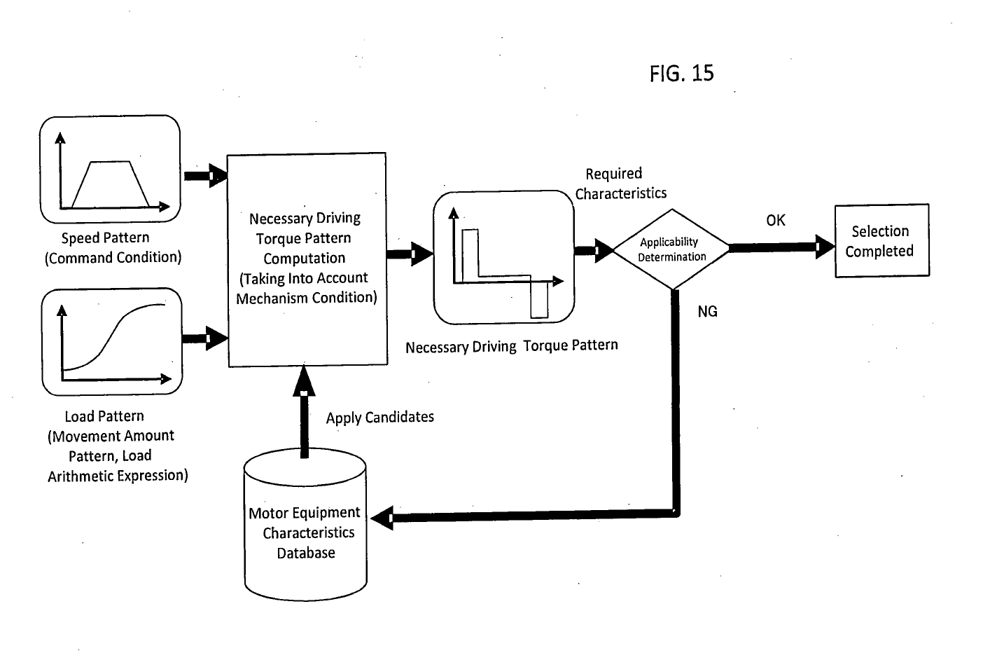

The above-described selection processing process is schematically summarized in FIG. 15. That is, based on the speed patterns that are input as the command condition, the movement amount patterns of the respective operation axes that are obtained by performing internal computation, and the load patterns that are obtained from the load arithmetic expressions that are input, the necessary driving torque patterns are computed. In the computation, the mechanism condition that is input is taken into account. Then, based on the calculated necessary driving torque patterns, the required characteristics are calculated, and the motor equipment that minimally satisfy the required characteristics are selected, and thereby, the selection processing is completed. In the present embodiment, such selection processing of the motor equipment with respect to the multi-axis drive system can be individually performed for each of the operation axes.

With regard to selection of peripheral equipment such as the encoder illustrated in FIG. 4, names of corresponding peripheral equipment and required characteristics are also stored in association with each other in the motor equipment characteristics database 121. When the above required characteristics are calculated, the required characteristics of the peripheral equipment are also calculated, and suitable peripheral equipment may be selected from the motor equipment characteristics database 121. Further, although not particularly illustrated in the drawings, when there are multiple motor equipment that match the required characteristics, names of all the motor equipment may be displayed as a list to allow the user to select from the list.

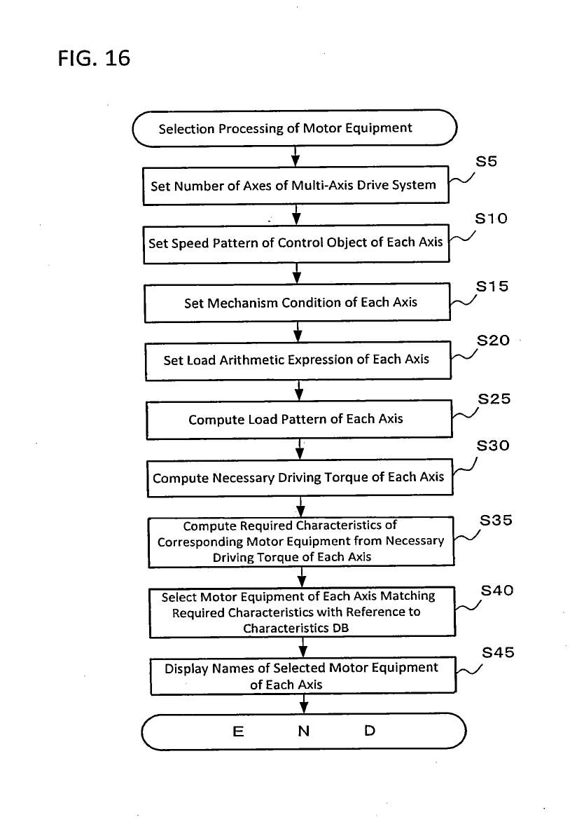

FIG. 16 illustrates an example of a flowchart illustrating control content that the CPU of the PC 1 executes in order to realize the above-described selection processing of motor equipment according to the present embodiment. The flow is started when the equipment selection application 100 starts up.

First, at step S5, the axis number input part 131 illustrated in FIG. 2 sets the number of axes of the multi-axis drive system (the X-Y table 200 of FIGS. 3A and 3B) to be designed, by an input operation from the user via the axis number input operation part 501 in FIG. 5.

Next, the processing proceeds to step S10, at which the command condition input part 132 illustrated in FIG. 2 sets the speed patterns of the control objects of the respective operation axes by an input operation of the user via the speed diagram setting operation part 502 in FIG. 5 (see FIGS. 6 and 7 for actual setting operation screens).

Next, the processing proceeds to step S15, at which the mechanism condition input part 133 illustrated in FIG. 2 sets mechanism conditions of the respective operation axes by an input operation of the user via the mechanism setting operation part 503 in FIG. 5 (see FIG. 8 for an actual setting operation screen).

Next, the processing proceeds to step S20, at which the load arithmetic expression input part 134 illustrated in FIG. 2 sets load arithmetic expressions of the respective operation axes by an input operation of the user via the load pattern setting operation part 504 in FIG. 5.

Next, the processing proceeds to step S25, at which the load pattern arithmetic part 111 illustrated in FIG. 2 computes load patterns of the respective operation axes by the processing described above using FIGS. 11 and 13.

Next, the processing proceeds to step S30, at which the necessary driving torque pattern arithmetic part 112 illustrated in FIG. 2 computes necessary driving torque patterns of the respective operation axes by the processing described above using FIG. 14.

Next, the processing proceeds to step S35, at which the required characteristics calculation part 113 illustrated in FIG. 2 calculates required characteristics of corresponding motor equipment from the necessary driving torque patterns of the respective operation axes.

Next, the processing proceeds to step S40, at which the motor equipment selection part 114 illustrated in FIG. 2 selects motor equipment that match the required characteristics of the respective operation axes by referring to the motor equipment characteristics database 121.

Next, the processing proceeds to step S45, at which the output part 140 illustrated in FIG. 2 displays names of the motor equipment of the respective operation axes that are selected at step S40. Then, the flow terminates.

The settings that are respectively performed at steps S10, S15 and S20 may be performed by the user in any order.

In the above, in the flow of FIG. 16, step S10 corresponds to a first display control step and a first display step; step S15 corresponds to a second display control step, a fifth display control step and a second display step; step S25 corresponds to a load pattern calculation step, a load pattern computation control step and a load pattern computation step; step S30 corresponds to a necessary driving torque pattern computation control step and a necessary driving torque pattern computation step; and step S45 corresponds to a third display control step, an equipment selection control step, a third display step and an equipment selection step.

As described above, according to the equipment selection application 100 of the present embodiment, peripheral equipment including a servo motor and a motor control device that are optimal for the respective driven mechanisms can be selected while taking into account variations of the load masses borne by the respective driven mechanisms. First, the user sets a speed pattern and a mechanism condition of a control object for each of operation axes corresponding to multiple driven mechanisms. Further, the user sets load arithmetic expressions for necessary operation axes. As a result, of the load masses of the control objects of the respective operation axes, variation of a shared load mass that is borne by sharing by an operation axis when operating in conjunction with other operation axes is obtained from a load arithmetic expression, and based on the variation of the share load mass, variation of the load mass of the control object of the operation axis alone is calculated (there may also be a case where the shared load mass is constant). Based on the variation of the load mass and the speed pattern, a necessary driving torque pattern and required characteristics of the operation axis are calculated. Based on the required characteristics, at least one servo motor and at least one servo controller that match the required characteristics are respectively selected from multiple servo motors and multiple servo controllers that are prepared in advance, and names of the selected at least one servo motor and at least one servo controller are displayed in a list.

As a result, the user can easily select a servo motor and a servo controller that are provided with proper specifications from the servo motors and servo controllers that are displayed in the list while taking into account variations of mass loads that are borne by the respective driven mechanisms in the multi-axis drive system to be designed.

Further, according the present embodiment, based on the load pattern that represents the variation of the load mass of the control object that is calculated by the load pattern arithmetic part 111 and the speed pattern that is set, the necessary driving torque pattern and the required characteristics of the operation axis are calculated. As a result, the servo motor and the servo controller that are provided with proper specifications can be reliably selected.

Further, according to the present embodiment, movement of a load mass that actually occurs due to operation of a control object that is performed by a driven mechanism is converted to an increase or decrease in an apparent fixed mass of a control object that is borne by another driven mechanism. That is, a phenomenon in which a load mass with a constant value moves is replaced by a phenomenon in which a value of an imaginary load mass positioned at a fixed point increases or decreases, and calculation is performed. As a result, the load pattern arithmetic part 111 can obtain the load pattern without performing complicated calculation.

Further, according to the present embodiment, the load pattern arithmetic part 111 multiplies a movement amount pattern of the X-axis by a predetermined load variable coefficient (inertia moment load variable coefficient), the movement amount pattern being obtained by integrating a speed pattern that is set corresponding to the X-axis, and adds an initial weight load of a load mass of a control object that is borne by the driven mechanism of the X-axis, and thereby, performs conversion to respective load patterns of the Y1-axis and the Y2-axis. As a result, the load pattern arithmetic part 111 can reliably obtain the load patterns without performing complicated calculation.

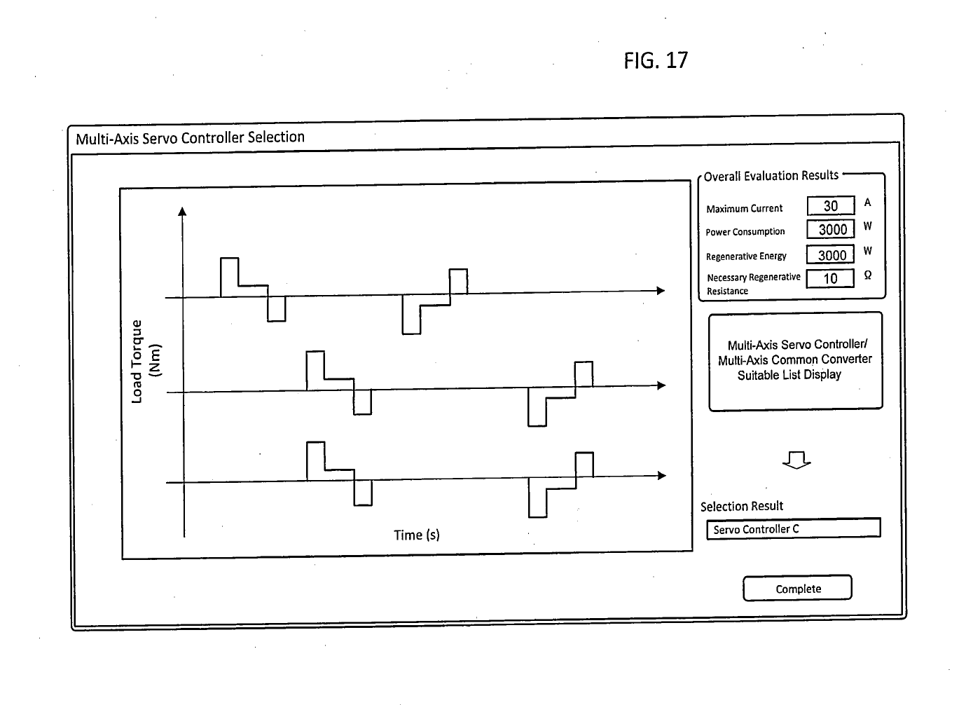

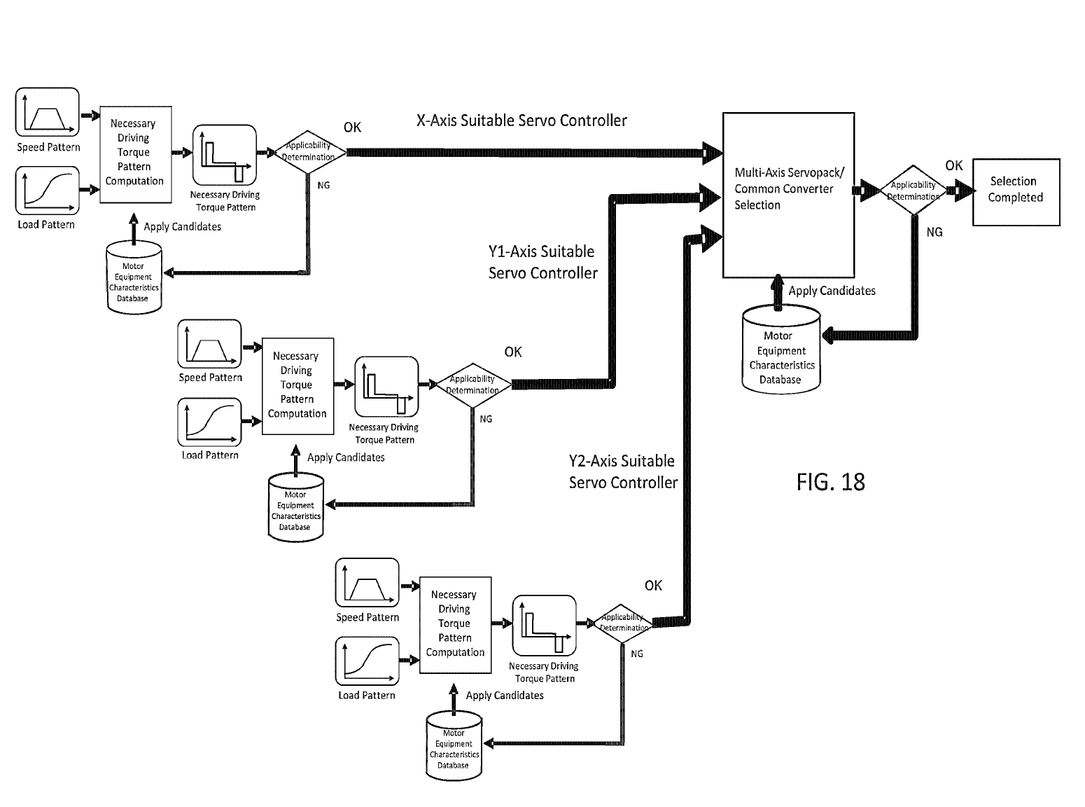

In the above embodiment, the servo controller is selected in one-to-one correspondence with the servo motor. That is, a case is described where a single-axis servo controller is selected. However, the present invention is not limited to this, and is also applicable in selecting a multi-axis servo controller that collectively controls multiple servo motors. For example, as illustrated in FIG. 17, which is displayed by operating the multi-axis selection operation part 507, it is also possible that the necessary driving torque patterns of the operation axes are put on the same time axis, required characteristics (such as a maximum current and power consumption) that can be realized at the same time are calculated, and a multi-axis servo controller or a multi-axis common converter that matches the required characteristics is selected. Alternatively, as illustrated in FIG. 18, it is also possible that a suitable single-axis servo controller is selected for each of the respective operation axes, and a multi-axis servo controller or a multi-axis common converter that matches collective characteristics of the single-axis servo controllers is selected. A screen in which at least one servo controller that is recommended in correspondence to all driven mechanisms is selected and displayed as described above corresponds to a fourth display part, and a control step to display this display screen corresponds to a fourth display control step.

As a result, after proper specifications are selected for each of the respective operation axes, a multi-axis servo controller or a multi-axis common converter that is optimal for the case where all of the operation axes (that is, all of the driven mechanisms) are controlled with one controller can be further recommended to the user.

Further, according to the present embodiment, the above-described setting screen of FIG. 7 is displayed in which multiple speed patterns are arranged and displayed on the same time axis, the speed patterns being respectively set using the above-described setting screen of FIG. 6 with respect to the respective operation axes of the driven mechanisms. The setting screen of FIG. 7 corresponds to a fifth display part. As a result, when the user selects one speed pattern for each of the operation axes, comparison between the operation axes and timing for operating in conjunction can be easily confirmed. Therefore, convenience can be further improved.

Further, according to the present embodiment, selection of servo motors is performed in the multi-axis drive system of the X-Y table 200 that has, as multiple driven mechanisms, the X-axis table movement mechanism 208 that performs a linear movement along the X-axis as an operation axis with respect to a load mass, the Y1-axis table movement mechanism 204 that supports one end portion of the X-axis table movement mechanism 208 and performs a linear movement along the Y1-axis as an operation axis with respect to the one end portion, and the Y2-axis table movement mechanism 205 that supports the other end portion of the X-axis table movement mechanism 208 and performs a linear movement along the Y2-axis as an operation axis parallel to the Y1-axis with respect to the other end portion.

As a result, servo motors and servo controllers that are provided with proper specifications can be easily selected with respect to a three-axis drive system in which the two end portions of the X-axis table movement mechanism 208 that moves a control object along the X-axis are linearly moved along the Y1-axis and Y2-axis directions by the Y1-axis table movement mechanism 204 and the Y2-axis table movement mechanism 205.

The above-described command condition is not limited to the input of a speed pattern. The command condition may also be input using another operation quantity such as a movement position pattern (movement amount pattern) of a control object.

The present invention is not limited to the above embodiment. Various modified embodiments are possible within the scope without departing from the spirit and the technical idea of the present invention. In the following, such modified embodiments are sequentially described.

(1) Case where Complicated Load Patterns are Calculated Using External Application

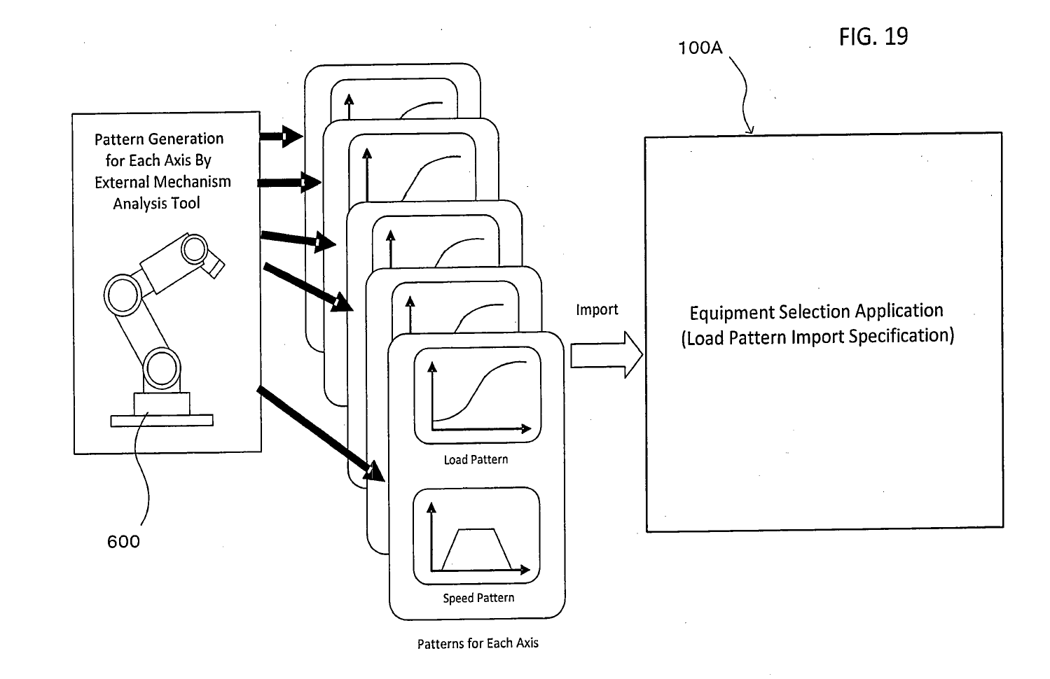

In the above-described embodiment, as an example of the multi-axis drive system, a case of a simple structure is described in which two axes, the Y1-axis and the Y2-axis, are aligned in parallel and coupled with respect to the common X-axis. However, as illustrated on a left side in FIG. 19, in a case of a multi-axis drive system such as an arm manipulator 600 having a structure in which operation axes are coupled in series and one end is structured as a free end, computation of load patterns corresponding to the respective operation axes by performing a large number of matrix integrations and the like becomes very difficult. When the computation of the respective load patterns of the operation axes is complicated and difficult as described above, it is also possible to perform processing in such a manner that the computation of the load patterns is performed using a dedicated external analysis application and the results are imported and used.

In this case, a command condition, a mechanism condition and load arithmetic expressions (such as an arithmetic expression based on a Newton-Euler method, and a Lagrange equation of motion) may be input using an equipment selection application (100A) and then export them to the external analysis application, or may be directly input to the external analysis application. Then, the equipment selection application (100A) of the present modified embodiment imports a combination of computed load patterns and speed patterns of the respective operation axes from the external analysis application and, based on the computed load patterns and speed patterns, computes necessary driving torque patterns of the respective operation axes. Corresponding required characteristics are respectively calculated from the necessary driving torque patterns of the respective operation axes, and names of suitable motor equipment are respectively selected.

In the above, a processing block in which a combination of a load pattern and a speed pattern is obtained for each driven mechanism from the external analysis application corresponds to a combination acquisition part and a combination acquisition step; an operation screen on which a mechanism condition of each operation axis is input corresponds to a sixth display part; a control step to display the operation screen corresponds to a sixth display control step and a fourth display step; a screen in which a name of a motor equipment selected based on the obtained combination of the load pattern and the speed pattern is displayed corresponds to a seventh display part; and a control step to display this display screen corresponds to a seventh display control step and a fifth display step.

As described above, according to the equipment selection application (100A) of the present modified embodiment, a combination of a load pattern and a speed pattern for each operation axis in a multi-axis drive system of a complicated structure can be obtained from the external analysis application. Therefore, while the equipment selection application (100A) itself can keep a simple structure, a servo motor and a servo controller that are provided with proper specifications for each operation axis can be easily selected in the same manner as in the above-described embodiment.

It is also possible that only a load pattern is imported from the external analysis application, and a speed pattern of a combination of the same operation axis is input and obtained using the equipment selection application (100A).

In the above-described embodiment and modified embodiments, the equipment selection applications (100, 100A) are each described as a form of a stand-alone application that is started by a program stored in an internal storage device (such as the HDD) of the PC 1. However, the equipment selection applications (100, 100A) may also be each configured as a form of a network application (web application) that is started when connected to an external server over the network.

Further, in addition to those already described above, methods according to the above-described embodiment and modified embodiments may be appropriately combined and used.

In Japanese Patent Laid-Open Publication No. 2006-42589, selection processing of servo motors in a multi-axis drive system that includes multiple driven mechanisms is not particularly considered.

An equipment selection processing device according to an embodiment of the present invention, an equipment selection processing program according to an embodiment of the present invention and an equipment selection processing method according to an embodiment of the present invention allow selection processing of servo motors and motor control devices of a multi-axis drive system that includes multiple driven mechanisms to be easily performed.

According to one aspect of the present invention, an equipment selection device is applied. The equipment selection device performs selection of peripheral equipment including servo motors and motor control devices in a multi-axis drive system in which multiple driven mechanisms operate in conjunction with each other based on driving forces of the servo motors. The equipment selection device includes a first display part, a second display part and a third display part. The first display part performs display to prompt selection of one speed pattern, for each operation axis, from multiple speed patterns that are prepared in advance. The second display part performs display to prompt selection of one of the driven mechanisms, for each operation axis, from the driven mechanisms that are prepared in advance. The third display part performs display to extract, for each operation axis, in response to the selection result of the driven mechanism corresponding to the display of the second display part, from multiple servo motors and multiple motor control devices that are prepared in advance, at least one servo motor and at least one motor control device that match variation of a load mass borne by the one selected driven mechanism when the one driven mechanism operates in conjunction with other driven mechanisms and match the selection result of the speed pattern related to the one driven mechanism, to display names of the at least one servo motor and at least one motor control device in a list, and to prompt selection from the displayed list.

According to another aspect of the present invention, an equipment selection device is applied. The equipment selection device performs selection of peripheral equipment including servo motors and motor control devices in a multi-axis drive system in which multiple driven mechanisms operate in conjunction with each other based on driving forces of the servo motors. The equipment selection device includes a combination acquisition part, a sixth display part and a seventh display part. The combination acquisition part acquires, for each driven mechanism, a combination of variation of a load mass that is borne by the one driven mechanism when operating in conjunction with other driven mechanisms and a speed pattern related to the one driven mechanism, the variation of the load mass and the speed pattern being obtained in advance for each operation mode when the multi-axis drive system performs predetermined operation modes. The sixth display part performs display to prompt selection of one of the driven mechanisms, for each operation axis, from the driven mechanisms that are prepared in advance. The seventh display part performs display to extract, for each operation axis, from multiple servo motors and multiple motor control devices that are prepared in advance, at least one servo motor and at least one motor control device that match the selection result of the driven mechanism corresponding to the display of the sixth display part and match the acquisition result of the combination acquisition part related to the selected one driven mechanism, to display the at least one servo motor and at least one motor control device in a list, and to prompt selection from the displayed list.

According to yet another aspect of the present invention, an equipment selection device is applied. The equipment selection device performs selection of peripheral equipment including servo motors and motor control devices in designing a multi-axis drive system in which multiple driven mechanisms that are each individually driven by one of the servo motors operate in conjunction with each other. The equipment selection device includes a load pattern arithmetic part, a necessary driving torque pattern arithmetic part and an equipment selection part. The load pattern arithmetic part computes a load pattern that represents a mode in which a load of an object operated by one driven mechanism selected from the driven mechanisms varies based on operations of other driven mechanisms. The necessary driving torque pattern arithmetic part computes a necessary driving torque pattern that is required by the servo motor that drives the one driven mechanism in order to operate the load represented by the load pattern by the operation of the one driven mechanism. The equipment selection part selects a servo motor and a motor control device that are suitable for driving the one driven mechanism based on the necessary driving torque pattern.

According to yet another aspect of the present invention, an equipment selection processing program is applied. The equipment selection processing program executes a first display control step, a second display control step and a third display control step with respect to an arithmetic part of an equipment selection device. The equipment selection device performs selection of peripheral equipment including servo motors and motor control devices in a multi-axis drive system in which multiple driven mechanisms operate in conjunction with each other based on driving forces of the servo motors, and is provided with the arithmetic part that performs predetermined computation and a display part that performs predetermined display. At the first display control step, a control signal is output to the display part, the control signal being for performing display to prompt selection of one speed pattern, for each operation axis, from multiple speed patterns that are prepared in advance. At the second display control step, a control signal is output to the display part, the control signal being for performing display to prompt selection of one of the driven mechanisms, for each operation axis, from the driven mechanisms that are prepared in advance. At the third display control step, a control signal is output to the display part, the control signal being for performing display to extract, for each operation axis, in response to the selection result of the driven mechanism corresponding to the display of the display part at the second display control step, from multiple servo motors and multiple motor control devices that are prepared in advance, at least one servo motor and at least one motor control device that match variation of a load mass borne by the one selected driven mechanism when the one driven mechanism operates in conjunction with other driven mechanisms and match the selection result of the speed pattern related to the one driven mechanism, to display names of the at least one servo motor and at least one motor control device in a list, and to prompt selection from the displayed list.

According to yet another aspect of the present invention, an equipment selection processing program is applied. The equipment selection processing program includes a combination acquisition step, a sixth display control step and a seventh display control step with respect to an arithmetic part of an equipment selection device. The equipment selection device performs selection of peripheral equipment including servo motors and motor control devices in a multi-axis drive system in which multiple driven mechanisms operate in conjunction with each other based on driving forces of the servo motors, and is provided with an arithmetic part that performs predetermined computation and a display part that performs predetermined display. At the combination acquisition step, for each driven mechanism, a combination of variation of a load mass that is borne by the one driven mechanism when operating in conjunction with other driven mechanisms and a speed pattern related to the one driven mechanism is acquired, the variation of the load mass and the speed pattern being obtained in advance for each operation mode when the multi-axis drive system performs multiple predetermined operation modes. At the sixth display control step, a control signal is output to the display part, the control signal being for performing display to prompt selection of one of the driven mechanisms, for each operation axis, from the driven mechanisms that are prepared in advance. At the seventh display control step, a control signal is output to the display part, the control signal being for performing display to extract, for each operation axis, from multiple servo motors and multiple motor control devices that are prepared in advance, at least one servo motor and at least one motor control device that match the selection result of the driven mechanism corresponding to the display of the display part at the sixth display control step and match the acquisition result of the combination acquisition step related to the selected one driven mechanism, to display names of the at least one servo motor and at least one motor control device in a list, and to prompt selection from the displayed list.

According to yet another aspect of the present invention, an equipment selection program is applied. The equipment selection program executes a load pattern computation control step, a necessary driving torque pattern computation control step and an equipment selection control step with respect to an arithmetic part of an equipment selection device. The equipment selection device performs selection of peripheral equipment including servo motors and motor control devices in designing a multi-axis drive system in which multiple driven mechanisms that are each individually driven by one of the servo motors operate in conjunction with each other. At the load pattern computation control step, a load pattern is computed that represents a mode in which a load of an object operated by one driven mechanism selected from the driven mechanisms varies based on operations of other driven mechanisms. At the necessary driving torque pattern computation control step, a necessary driving torque pattern is computed that is required by the servo motor that drives the one driven mechanism in order to operate the load represented by the load pattern by the operation of the one driven mechanism. At the equipment selection control step, a servo motor and a motor control device are selected that are suitable for driving the one driven mechanism based on the necessary driving torque pattern.

According to yet another aspect of the present invention, an equipment selection processing method is applied. The equipment selection processing method is executed by an equipment selection device and includes a first display step, a second display step and a third display step. The equipment selection device performs selection of peripheral equipment including servo motors and motor control devices in a multi-axis drive system in which multiple driven mechanisms operate in conjunction with each other based on driving forces of the servo motors. The first display step performs display to prompt selection of one speed pattern, for each operation axis, from multiple speed patterns that are prepared in advance. The second display step performs display to prompt selection of one of the driven mechanisms, for each operation axis, from the driven mechanisms that are prepared in advance. The third display step performs display to extract, for each operation axis, in response to the selection result of the driven mechanism corresponding to the display of the second display step, from multiple servo motors and multiple motor control devices that are prepared in advance, at least one servo motor and at least one motor control device that match variation of a load mass borne by the one selected driven mechanism when the one driven mechanism operates in conjunction with other driven mechanisms and match the selection result of the speed pattern related to the one driven mechanism, to display names of the at least one servo motor and at least one motor control device in a list, and to prompt selection from the displayed list.

According to yet another aspect of the present invention, an equipment selection processing method is applied. The equipment selection processing method is executed by an equipment selection device and includes a combination acquisition step, a fourth display step and a fifth display step. The equipment selection device performs selection of peripheral equipment including servo motors and motor control devices in a multi-axis drive system in which multiple driven mechanisms operate in conjunction with each other based on driving forces of the servo motors. The combination acquisition step acquires, for each driven mechanism, a combination of variation of a load mass that is borne by the one driven mechanism when operating in conjunction with other driven mechanisms and a speed pattern related to the one driven mechanism, the variation of the load mass and the speed pattern being obtained in advance for each operation mode when the multi-axis drive system performs predetermined operation modes. The fourth display step performs display to prompt selection of one of the driven mechanisms, for each operation axis, from the driven mechanisms that are prepared in advance. The fifth display step performs display to extract, for each operation axis, from multiple servo motors and multiple motor control devices that are prepared in advance, at least one servo motor and at least one motor control device that match the selection result of the driven mechanism corresponding to the display of the fourth display step and match the acquisition result of the combination acquisition step related to the selected one driven mechanism, to display names of the at least one servo motor and at least one motor control device in a list, and to prompt selection from the displayed list.

According to yet another aspect of the present invention, an equipment selection processing method is applied. The equipment selection processing method is executed by an equipment selection device and includes a load pattern computation step, a necessary driving torque pattern computation step and an equipment selection step. The equipment selection device performs selection of peripheral equipment including servo motors and motor control devices in designing a multi-axis drive system in which multiple driven mechanisms that are each individually driven by one of the servo motors operate in conjunction with each other. The load pattern computation step computes a load pattern that represents a mode in which a load of an object operated by one driven mechanism selected from the driven mechanisms varies based on operations of other driven mechanisms. The necessary driving torque pattern computation step computes a necessary driving torque pattern that is required by the servo motor that drives the one driven mechanism in order to operate the load represented by the load pattern by the operation of the one driven mechanism. The equipment selection step selects a servo motor and a motor control device that are suitable for driving the one driven mechanism based on the necessary driving torque pattern.

According to an embodiment of the present invention, an operator can easily select a servo motor and a motor control device that are provided with proper specifications from names of servo motors and motor control devices that are displayed in a list while taking into account variation of a mas load borne by each driven mechanism in a multi-axis drive system of a structure that the operator desires.

Obviously, numerous modifications and variations of the present invention are possible in light of the above teachings. It is therefore to be understood that within the scope of the appended claims, the invention may be practiced otherwise than as specifically described herein.

What is claimed is:

1. An equipment selection device for selecting peripheral equipment including servo motors and motor control devices in a multi-axis drive system in which a plurality of driven mechanisms operate in conjunction with each other based on driving forces of the servo motors, comprising:
circuitry configured to
receive, for each operation axis, a selection of a speed pattern from a plurality of available speed patterns that are determined in advance,
receive, for each operation axis, a selection of a driven mechanism from a plurality of available driven mechanisms that are determined in advance,
extract, for each operation axis, in response to receiving the selection of the driven mechanism and from a plurality of servo motors and a plurality of motor control devices that are determined in advance, at least one servo motor and at least one motor control device that match variation of a load mass borne by the selected driven mechanism when operating in conjunction with other driven mechanisms and that match the selected speed pattern,
generate a list from the extracted at least one servo motor and at least one motor control device,
display the list including the at least one servo motor and the at least one motor control device, and
receive selection from the list of a servo motor and a motor control device.

2. The equipment selection device according to claim 1, wherein the circuitry is further configured to compute, for each operation axis, the variation of a load mass borne by the selected driven mechanism when operating in conjunction with other driven mechanisms, in response to receiving the selection of the driven mechanism and from the plurality of servo motors and the plurality of motor control devices that are determined in advance, and display the list including the at least one servo motor and the at least one motor control device that match the variation of a load mass and the selected speed pattern.

3. The equipment selection device according to claim 2, wherein the circuitry is configured to compute the variation of a load mass borne by the selected driven mechanism when operating in conjunction with other driven mechanisms by converting movement of the load mass to an increase or decrease in an apparent fixed mass borne by the selected driven mechanism.

4. The equipment selection device according to claim 3, wherein the circuitry is configured to convert the movement of the load mass by multiplying variation of a movement amount obtained by integrating the selected speed pattern by a load variable coefficient and adding an initial weight load of the load mass borne by the selected driven mechanism.

5. The equipment selection device according to claim 1, wherein the circuitry is further configured to display at least one suitable motor control device that matches the selected driven mechanism in response to receiving the selection of the driven mechanism for each operation axis.

6. The equipment selection device according to claim 1, wherein the circuitry is further configured to display the selected speed pattern arranged on the same time axis for each operation axis.

7. The equipment selection device according to claim 1, wherein the circuitry is further configured to select the at least one servo motor in a multi-axis drive system comprising the plurality of driven mechanisms including an X-axis driven mechanism configured to perform a linear movement along an X-axis as an operation axis with respect to a load mass, a Y1-axis driven mechanism supporting one end portion of the X-axis driven mechanism and configured to perform a linear movement along a Y1-axis as an operation axis with respect to the one end portion, and a Y2-axis driven mechanism supporting the other end portion of the X-axis driven mechanism and configured to perform a linear movement along a Y2-axis as an operation axis parallel to the Y1-axis with respect to the other end portion.

8. A computer readable medium having stored thereon a program that when executed by a computer causes the computer having circuitry to execute an equipment selection method for selecting peripheral equipment including servo motors and motor control devices in a multi-axis drive system in which a plurality of driven mechanisms operate in conjunction with each other based on driving forces of the servo motors, the equipment selection method comprising:
receiving, for each operation axis, a selection of a speed pattern from a plurality of available speed patterns;
receiving, for each operation axis, a selection of a driven mechanism from a plurality of available driven mechanisms that are determined in advance;
extracting, using the circuitry, for each operation axis, in response to receiving the selection of the driven mechanism, and from a plurality of servo motors and a plurality of motor control devices that are determined in advance, at least one servo motor and at least one motor control device that match variation of a load mass borne by the selected driven mechanism when operating in conjunction with other driven mechanisms and that match the selected speed pattern;
generating, using the circuitry, a list from the extracted at least one servo motor and at least one motor control device;
displaying the list including the at least one servo motor and the at least one motor control device; and
receiving selection from the list of a servo motor and a motor control device.

9. The computer readable medium according to claim 8, wherein the equipment selection method further includes computing, for each operation axis, the variation of a load mass borne by the selected driven mechanism when operating in conjunction with other driven mechanisms, in response to receiving the selection of the driven mechanism and from the plurality of servo motors and the plurality of motor control devices that are determined in advance, and displaying the list including the at least one servo motor and the at least one motor control device that match the variation of a load mass and the selected speed pattern.

10. The computer readable medium according to claim 9, wherein the computing of the variation of a load mass borne by the selected driven mechanism when operating in conjunction with other driven mechanisms includes converting movement of the load mass to an increase or decrease in an apparent fixed mass borne by the selected driven mechanism.

11. The computer readable medium according to claim 10, wherein the converting of the movement of the load mass includes multiplying variation of a movement amount obtained by integrating the selected speed pattern by a load variable coefficient and adding an initial weight load of the load mass borne by the selected driven mechanism.

12. The computer readable medium according to claim 8, wherein the equipment selection method further includes displaying at least one suitable motor control device that matches the selected driven mechanism in response to receiving the selection of the driven mechanism for each operation axis.

13. The computer readable medium according to claim 8, wherein the equipment selection method further includes displaying the selected speed pattern arranged on the same time axis for each operation axis.

14. The computer readable medium according to claim 8, wherein the equipment selection method further includes selecting the at least one servo motor in a multi-axis drive system comprising the plurality of driven mechanisms including an X-axis driven mechanism configured to perform a linear movement along an X-axis as an operation axis with respect to a load mass, a Y1-axis driven mechanism supporting one end portion of the X-axis driven mechanism and configured to perform a linear movement along a Y1-axis as an operation axis with respect to the one end portion, and a Y2-axis driven mechanism supporting the other end portion of the X-axis driven mechanism and configured to perform a linear movement along a Y2-axis as an operation axis parallel to the Y1-axis with respect to the other end portion.

15. An equipment selection method for selecting peripheral equipment including servo motors and motor control devices in a multi-axis drive system in which a plurality of driven mechanisms operate in conjunction with each other based on driving forces of the servo motors, the equipment selection method comprising:
receiving, for each operation axis, a selection of a speed pattern from a plurality of available speed patterns;
receiving, for each operation axis, a selection of a driven mechanism from a plurality of available driven mechanisms that are determined in advance;
extracting, using circuitry, for each operation axis, in response to receiving the selection of the driven mechanism, and from a plurality of servo motors and a plurality of motor control devices that are determined in advance, at least one servo motor and at least one motor control device that match variation of a load mass borne by the selected driven mechanism when operating in conjunction with other driven mechanisms and that match the selected speed pattern;
generating, using the circuitry, a list from the extracted at least one servo motor and at least one motor control device;
displaying the list including the at least one servo motor and the at least one motor control device; and
receiving selection from the list of a servo motor and a motor control device.

16. The equipment selection method according to claim 15, further comprising:
computing, for each operation axis, the variation of a load mass borne by the selected driven mechanism when operating in conjunction with other driven mechanisms, in response to receiving the selection of the driven mechanism and from the plurality of servo motors and the plurality of motor control devices that are determined in advance; and
displaying the list including the at least one servo motor and the at least one motor control device that match the variation of a load mass and the selected speed pattern.

17. The equipment selection method according to claim 16, wherein the computing of the variation of a load mass borne by the selected driven mechanism when operating in conjunction with other driven mechanisms includes converting movement of the load mass to an increase or decrease in an apparent fixed mass borne by the selected driven mechanism.

18. The equipment selection method according to claim 17, wherein the converting of the movement of the load mass includes multiplying variation of a movement amount obtained by integrating the selected speed pattern by a load variable coefficient and adding an initial weight load of the load mass borne by the selected driven mechanism.

19. The equipment selection method according to claim 15, further comprising:
displaying at least one suitable motor control device that matches the selected driven mechanism in response to receiving the selection of the driven mechanism for each operation axis.

20. The equipment selection method according to claim 15, further comprising:
displaying the selected speed pattern arranged on the same time axis for each operation axis.
